(19) United States
(12) Patent Application Publication
(10) Pub. No.: US 2013/0332524 A1
(43) Pub. Date: Dec. 12, 2013

(54) DATA SERVICE ON A MOBILE DEVICE

(71) Applicants: GARRICK FIALA, Seminole, FL (US); PETR FRANEK, Praha (CZ); ROMAN CERVENKA, Praha (CZ)

(72) Inventors: GARRICK FIALA, Seminole, FL (US); PETR FRANEK, Praha (CZ); ROMAN CERVENKA, Praha (CZ)

(73) Assignee: INTERMEC IP CORP., Everett, WA (US)

(21) Appl. No.: 13/494,969

(22) Filed: Jun. 12, 2012

(51) Int. Cl. G06F 15/16

(52) U.S. Cl. 709/204; 709/217

(57) ABSTRACT

A data service residing on a client of a mobile computing device is disclosed for enabling network communications between a plurality of mobile applications on the device and a network for a process number. The data service communicates with a data service plug-in on the server side associated with the process number, in order to handle requests from the business applications that access the network through the data service. The data service is configured to accept commands from the plurality of mobile applications using a text-based mark-up language and handles typical communication needs of business applications, such as sending and receiving data.

### CROSS REFERENCE TO RELATED APPLICATIONS

This application is related to application Ser. No. ______ entitled application “Communication Protocol and System for Network Communications” filed contemporaneously herewith and Application S/N entitled “System and Process for Managing Network Communication” filed contemporaneously herewith.

### TECHNICAL FIELD

The present disclosure relates to mobile devices and more particularly to communications between business applications on a mobile computing device and a network

### BACKGROUND

Mobile computing systems are used daily, in a wide range of industries, with applications such as route accounting, pre-sales, field services, parcel delivery, medical services, retail, warehousing, public safety and public services. To tailor a mobile computing device used in a mobile computing system to a particular industry application, the mobile computing device is typically provided with one or more business applications that configure the mobile computing device for that particular industry application use. For example, a mobile computing device, such as a scanning device, may be provided with a business application for managing inventory. This business application will generally set the settings of the scanner to the settings required to satisfy the communication needs of the business application, such as sending and receiving data to and from the business application. With the scanner so configured, the business application will then be able to recognize and store inventory data captured by the scanner into data files and to manipulate and communicate that data to a network to allow the user to manage the inventory at, for example, a warehouse.

Each of these business applications is generally designed to meet the special needs of that industry's mobile workforce, and as a result, these applications have different functionality which leads to different data structures, data-flow, work-flow, user interfaces, and supported peripherals.

Conventional business applications may manage communications with the network directly in which case the business application will handle details of the communication itself. For example, it will typically open a network connection with a host server, such as a web server, and interact directly with the host system through whatever interface it exposes to address commands to the server, receive results, etc. Alternatively, business applications may use an application program interface (API) to assist in that management that allows them to access the network using a set of pre-defined functions that are part of the API.

A business application that uses the API to handle communications over the network will typically manage details of the network communication itself, using the API. For example, the API will assist the business application in opening a network connection with a host server, such as a web server, and interact directly with the host system through whatever interface it exposes to address commands to the server, receive results, etc. In either case, all of this requires that the designer of business applications have a thorough understanding of all of the details of the network, network protocols, servers, etc., and, in the case of the business application that uses the API, have a thorough understanding of the API as well. This can be a considerable burden for the developers of business applications with typical communication needs.

The requirement that a business application typically manage details of the network communication itself, alone or using the API, makes it difficult to scale the mobile computing system since diverse business applications have different network communication requirements. This requirement that a business application typically manages details of the network communication itself, alone or using the API, also leads to segmentation of the business applications at the network communication level; making it harder for the administrator to manage the rules that govern the network communications. It is harder to manage communications because typically each mobile application would independently, only for its own use, establish a communications session, through any network that was available, to any host system and the administrator has no way to monitor or manage what mobile applications are communicating from the device, with what server side resources, what data is being requested and submitted between the device/application and host system, who was the device user associated with the data exchange, how long the session took, through what network it's being executed, etc. It also makes the network less open and less extendible to meet the specific needs of each organization since some business applications may not be configurable for use with or it may be difficult to configure the business application for use with the network which may mean that a business application may not get used with a network. The requirement that a business application typically manages details of the network communication itself, alone or using the API, also means that each business application will have a separate communication link with the network which creates more channels of communication with the network. This means that there are more communication channels that the network needs to manage. It also means that there are more channels of communication that are open to a security breach.

There is a need for a mobile computing system in which any number of mobile business applications running on the same device (and running on any number of devices and device types) can exchange data in parallel with any number of host system resources. There is a need for a mobile computing system in which the details of the network communication between a business application residing on a mobile computing device and a network or host system are made more uniform. There is a need for a unified approach to implementing connectivity between mobile applications and host systems that improves mobile communication flexibility and reliability and management, enhances data transmission security, enables better mobile device management and mobile application support, enables extensive control over mobile data exchange transactions, enables mobile computing devices to be more quickly and efficiently used on the network, provides an integrated and yet highly scalable solution, and enables comprehensive monitoring of all communications and data processing. This disclosure addresses those needs.

### SUMMARY OF THE INVENTION

A shared data service residing on a client of a source, such as a mobile computing device, is disclosed for enabling network communications between a plurality of mobile applications on the source and a network for a process number. The data service is configured to accept commands from the plurality of mobile applications using a text-based mark-up language. The shared data service is a single instance of a process executing on the source, such as a mobile device, that handles the typical communication needs of business applications, such as sending and receiving data. The shared data service process takes care of details such as initiating network communications, opening a network connection to a gateway server, determining the server with which it will communicate, etc. Generally, the shared data service communicates with a data service plug-in on the server side associated with the process number, in order to handle requests from the business applications that access the network through the data service.

In some embodiments, a mobile computing device includes a memory, a processor in communication with the memory, and a plurality of connections in communication with the processor for communicating via a corresponding plurality of connection types with a network. The processor is configured to execute a plurality of mobile applications. The processor is further configured to execute a single instance of a data service that provides network communications between the plurality of mobile applications and a server. The data service may be configured to accept commands from the plurality of mobile applications using a text-based mark-up language.

In some embodiments, the text-based mark-up language is based on a standardized extensible markup language (XML). In some embodiments, the data service is configured according to contents of a configuration file, and mobile applications register in the configuration file to use the data service. In some embodiments, the data service is configured to accept commands from each mobile application through a command file associated with the mobile application.

In some embodiments a method is disclosed including: providing a single instance of a data service executing on a mobile device, the data service providing network communications between a plurality of mobile applications on the mobile device and a server; and accepting commands for the data service from the plurality of mobile applications, the commands instructing the data service to send data to or receive data from the server. In some embodiments, the commands are provided using a text-based markup language.

In some embodiments, a mobile device includes a memory, a processor in communication with the memory, and a plurality of connections in communication with the processor for communicating via a corresponding plurality of connection types with a network. The processor is configured to execute a plurality of mobile applications. The processor is further configured to execute a data service that provides network communications between the plurality of mobile applications and a server. The data service is configured to accept data exchange requests from the mobile applications to establish communications between a requesting application and the network based on the data exchange request of the requesting application.

In some embodiments, a method includes: accepting data exchange requests from a plurality of business applications via a data service of a mobile device; and for each data exchange request, establishing a communication between the requesting application and a network based on the data exchange request of the requesting application.

In some embodiments, a computer readable medium is disclosed for storing instructions which when executed by a processor cause the processor to perform a method. The method includes: accepting data exchange requests from a plurality of business applications via a data service of a mobile device; and for each data exchange request, establishing a communication between the requesting application and a network based on the data exchange request of the requesting application

Other embodiments are also disclosed.

### BRIEF DESCRIPTION OF THE DRAWINGS

FIG. 1 shows an illustrative embodiment of a high-level view of a network communication architecture for a mobile device.

FIG. 2 shows an illustrative embodiment of a configuration file for a data service.

FIG. 3 shows an illustrative embodiment of a command file for use by a business application in sending commands to a data service.

FIG. 4 shows an illustrative embodiment of another example command file that sends files across a network to a server.

FIG. 5 shows an illustrative embodiment of another example command file that instructs a data service to receive a file from a server.

FIG. 6 shows an illustrative embodiment of another example of a command file.

FIG. 7 shows an illustrative embodiment of a further example of a command file.

FIG. 8 shows an illustrative embodiment of a block diagram of a computing system according to the present disclosure.

FIG. 9 shows an illustrative embodiment of a client request of a network to establish a valid connection to the network according to the present disclosure.

FIG. 10 shows an embodiment of a process by which a communication path or channel is established between the client and the system according to the present disclosure.

FIG. 11 shows an illustrative embodiment of the system setup and management of connection paths according to the present disclosure.

FIG. 12 shows a client having a business application that makes three process requests.

FIG. 13 shows an embodiment of a creation of a new session in an existing connection path according to the present disclosure.

FIG. 14 shows an embodiment of a client having a business application that makes three process requests according to the present disclosure.

FIG. 15 shows an embodiment of a structure of communication connections according to the present disclosure.

FIG. 16 shows an illustrative embodiment of a mobile computer wishing to download a process according to the present disclosure.

FIG. 17 shows an embodiment of a system for “pull” and “push” data communication according to the present invention.

FIG. 18 shows an embodiment of a system with a check point restart on download feature according to the present invention.

FIG. 19 shows an embodiment of a process for updating mobile applications according to the present invention

FIG. 20 shows an embodiment of a window that may appear on a display of a system manager illustrating the management of communications between mobile devices and host systems by grouping system codes into connection groups according to the present invention

FIG. 21 shows an embodiment of a process for determining which connection path should be used according to the present invention

FIG. 22 shows an embodiment of a functional diagram and a process for updating connection rules onto a client according to the present invention.

### DETAILED DESCRIPTION

A shared data service residing on a client of a source, such as a mobile computing device, is disclosed for enabling network communications between a plurality of mobile applications on the source and a network for a process number. The data service is configured to accept commands from the plurality of mobile applications using a text-based mark-up language. The shared data service may be a single instance of a process executing on the source, such as a mobile device, that handles the typical communication needs of business applications, such as sending and receiving data. The shared data service process takes care of details such as initiating network communications, opening a network connection to a gateway server, determining the server with which it will communicate, etc. Generally, the shared data service communicates with a data service plug-in on the server side associated with the process number, in order to handle requests from the business applications that access the network through the data service. The particulars of the protocol for use with the disclosed data service for managing communications between a plurality of mobile applications on a source and a network for a process number can be found in application entitled “Communication Protocol and System for Network Communications” filed contemporaneously herewith and is incorporated herein by reference. The particulars of the system for use with the disclosed data service for network management of a plurality of mobile applications on a source by a process number can be found in application entitled “System and Process for Managing Network Communications” filed contemporaneously herewith and is incorporated herein by reference.

In some embodiments, a mobile computing device includes a memory, a processor in communication with the memory, and a plurality of connections in communication with the processor for communicating via a corresponding plurality of connection types with a network. The processor is configured to execute a plurality of mobile applications. The processor is further configured to execute a single instance of a data service that provides network communications between the plurality of mobile applications and a server. The data service may be configured to accept commands from the plurality of mobile applications using a text-based mark-up language.

In some embodiments, the text-based mark-up language is based on a standardized extensible markup language (XML).

In some embodiments, the data service is configured according to contents of a configuration file, and mobile applications register in the configuration file to use the data service

In some embodiments, the data service is configured to accept commands from each mobile application through a command file associated with the mobile application.

In some embodiments a method is disclosed including: providing a single instance of a data service executing on a mobile device, the data service providing network communications between a plurality of mobile applications on the mobile device and a server; and accepting commands for the data service from the plurality of mobile applications, the commands instructing the data service to send data to or receive data from the server. In some embodiments, the commands are provided using a text-based markup language.

In some embodiments, the mobile device includes a memory, a processor in communication with the memory, and a plurality of connections in communication with the processor for communicating via a corresponding plurality of connection types with a network. The processor is configured to execute a plurality of mobile applications. The processor is further configured to execute a data service that provides network communications between the plurality of mobile applications and a server. The data service is configured to accept data exchange requests from the mobile applications to establish communications between a requesting application and the network based on the data exchange request of the requesting application.

In some embodiments, the data exchange request contains a configuration file for configuring the data service to establish a connection between the requesting application and the network in accordance with a process identified by the configuration file.

In some embodiments, the data service initiates a connection with the network in response to the data exchange request for downloading a set of data associated with the requested process for configuring the data service in accordance with the process identified by the configuration file requested by the data exchange request from the requesting application.

In some embodiments, the requested process configures the data service to establish a connection between the requesting business application and the network based on a priority rule.

In some embodiments the priority rule creates a priority between a plurality of communication protocols and wherein the data service is configured to use a one of the plurality of communication protocols available to the mobile device according to the priority for the connection to the network requested by the application.

In some embodiments, the priority rule creates a priority between a plurality of periods of time and wherein the data service is configured to establish the connection of the requesting application to the network during one of the periods of time according to the priority.

In some embodiments, the requested process configures the data service to establish a first connection between the requesting application and the network based on a first priority rule and a second requested process configures the data service to establish a second connection between a second requesting application and the network based on a second priority rule.

In some embodiments the requested process configures the data service to establish a first connection between the requesting application and the network based on a first priority rule and a second requested process configures the data service to establish a session with the first connection between a second requesting application and the network based on a second priority rule.

In some embodiments, the mobile device is configured to route all communications of the business applications through the data service.

In some embodiments, an agent is configured to be executed on the processor and being configured to monitor the mobile applications and to restart any mobile application which stops running

In some embodiments, a message service configured to be executed on the processor and to receive a push message from the network and to forward the push message to a mobile application associated with the push message.

In some embodiments, a method includes: accepting data exchange requests from a plurality of business applications via a data service of a mobile device; and for each data exchange request, establishing a communication between the requesting application and a network based on the data exchange request of the requesting application.

In some embodiments, a computer readable medium is disclosed for storing instructions which when executed by a processor cause the processor to perform a method. The method includes: accepting data exchange requests from a plurality of business applications via a data service of a mobile device; and for each data exchange request, establishing a communication between the requesting application and a network based on the data exchange request of the requesting application.

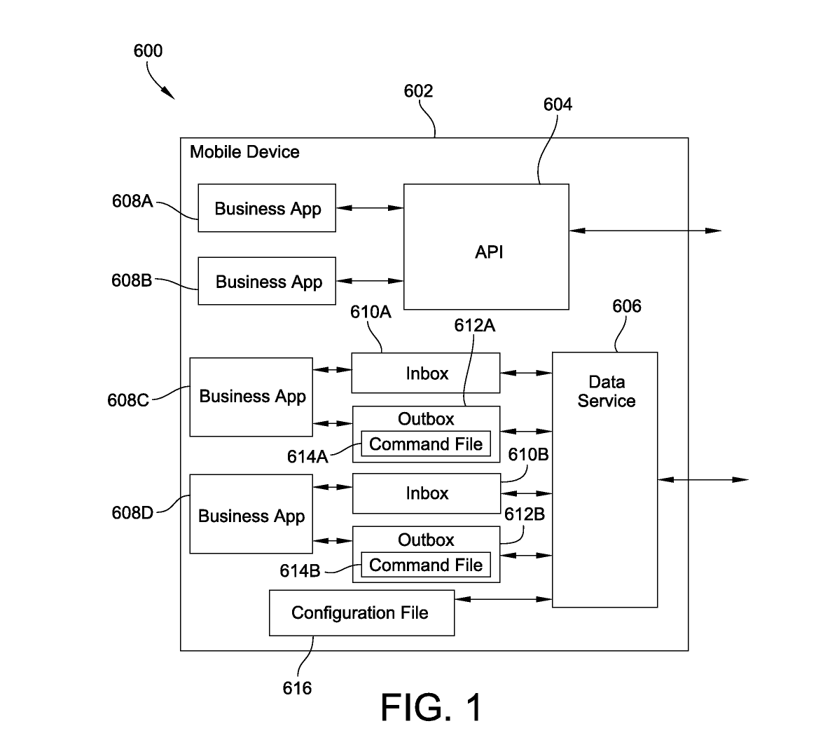

Turning now to describing the shared service residing on a client of a source, such as a mobile computing device for enabling network communications between a plurality of mobile applications on the source and a network for a process number and how the data service may be configured to accept commands from the plurality of mobile applications using a text-based mark-up language, such as XML, reference is made to FIG. 1 which shows a high-level view of a network communication architecture 600 for a mobile device 602. As will be understood, the various modules described with reference to FIG. 1 are stored in a memory (not shown) of the mobile device 602, and executed on a processor (not shown) of the mobile device 602, as described hereinabove.

The mobile device 602 executes numerous business applications 608a-d, which communicate across a network (not shown). Some of these business applications, such as business applications 608a and 608b communicate with the network using an application program interface (API) 604, that allows them access the network using a set of pre-defined functions that are part of the API 604. A business application, such as business applications 608a and 608b, that uses the API 604 to handle communications over the network will typically manage details of the network communication itself, using the API 604. For example, it will typically open a network connection with a gateway server, determine what server and/or server plug-in to use, address commands to the server and/or server-plug-in, receive results, etc. All of this requires that the designer of business applications that use the API 604 have a thorough understanding of the API 604 and of all of the details of the network, network protocols, servers, etc. This can be a considerable burden for the developers of business applications with typical communication needs.

Alternatively, in accordance with various embodiments of the invention, some of the business applications, such as business applications 608c and 608d may make use of a shared data service 606 to communicate across the network. As will be described in greater detail below, the shared data service 606 is a single instance of a process executing on the mobile device 602 that handles the typical communication needs of business applications, such as sending and receiving data. The shared data service process 606 takes care of details such as initiating network communications, opening a network connection to a gateway server, determining the server with which it will communicate, etc. Generally, the shared data service 606 communicates with a data service plug-in (not shown) on the server side, in order to handle requests from the business applications that access the network through the data service 606.

In some embodiments, the shared data service 606 accepts commands from business applications, such as business applications 606c and 606d, through command files, such as the command file 614a, which provides commands from the business application 608c, or the command file 614b, which provides commands from the business application 608d. As will be described in greater detail below, these command files may be written at a high level, in a text-based markup language, such as the standard extensible markup language (XML) or other markup languages. When the data service 606 receives a command file from a business application, it parses the command file, and interprets the commands in the command file to carry out network communication tasks on behalf of the business application from which the command file was received.

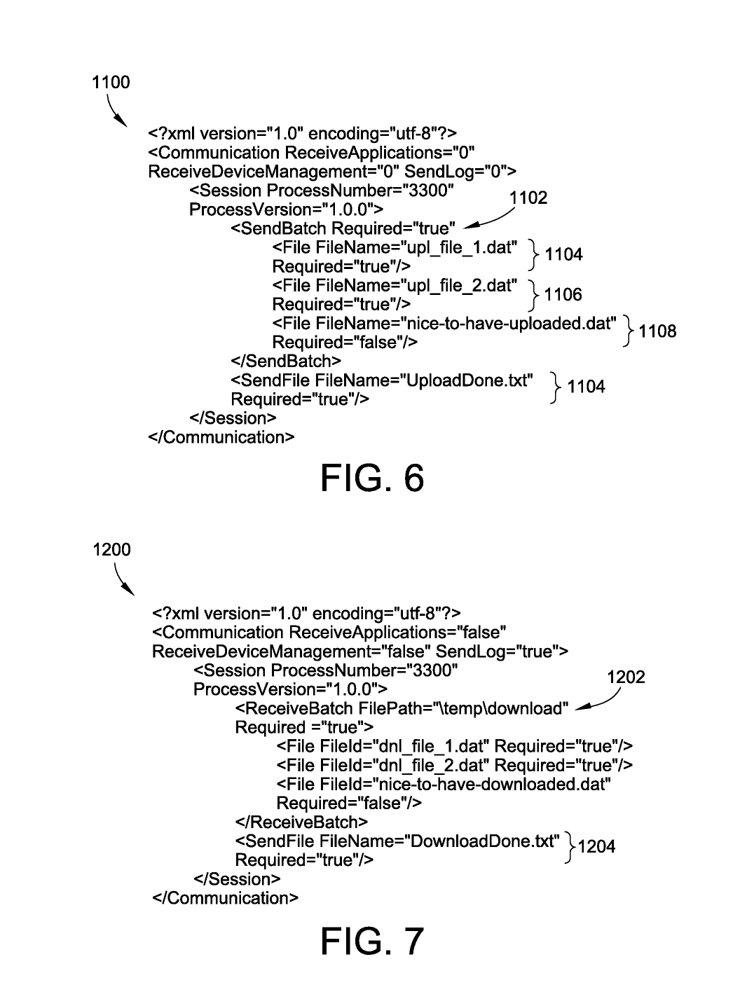

In some embodiments, the data service 606 communicates with business applications, such as the business applications 608c and 608d, through directories that are established in a memory or storage system of the mobile device. These directories include an inbox directory, such as inbox directories 610a and 610b, and an outbox directory, such as out box directories 612a and 612b, for each business application. The inbox directory is used for files that are incoming from the data service 606 (and probably from the network) to the business application, and the outbox directory is for files that are being sent out to the data service 606 and to the network. For example, in the embodiment shown in FIG. 6, the command files 614a and 614b, which are being sent to the data service 606 by business applications 608c and 608d, are placed in outbox directories 612a and 612b.

The business applications that are communicating with the data service 606 and the directories that will be used for that communication are configured in a configuration file 616. As will be discussed in greater detail below, in some embodiments, the configuration file 616 may written in a text-based markup language, such as XML, which is parsed and interpreted by the data service 606.

By using a data service, such as the data service 606, business applications are not burdened with having to handle all of the low-level details of network communications. Further, since there is only a single data service 606 that takes commands from numerous business applications, the data service 606 can do a better job of optimizing the network communications, since a single process has an overview of all of the communications of the various business applications that use the data service 606, rather than having each business application handle its own communications. Additionally, by using command files that specify high-level communication commands that are typically used by business applications, it is easier for developers of business applications to create new business applications, since they are no longer burdened with handling (and understanding) all of the low-level details of network communications. Further, by using a text-based markup language, such as XML, to send instructions to the data service, developers of business applications can send instructions to the data service using pre-defined commands in a well-known syntactic structure.

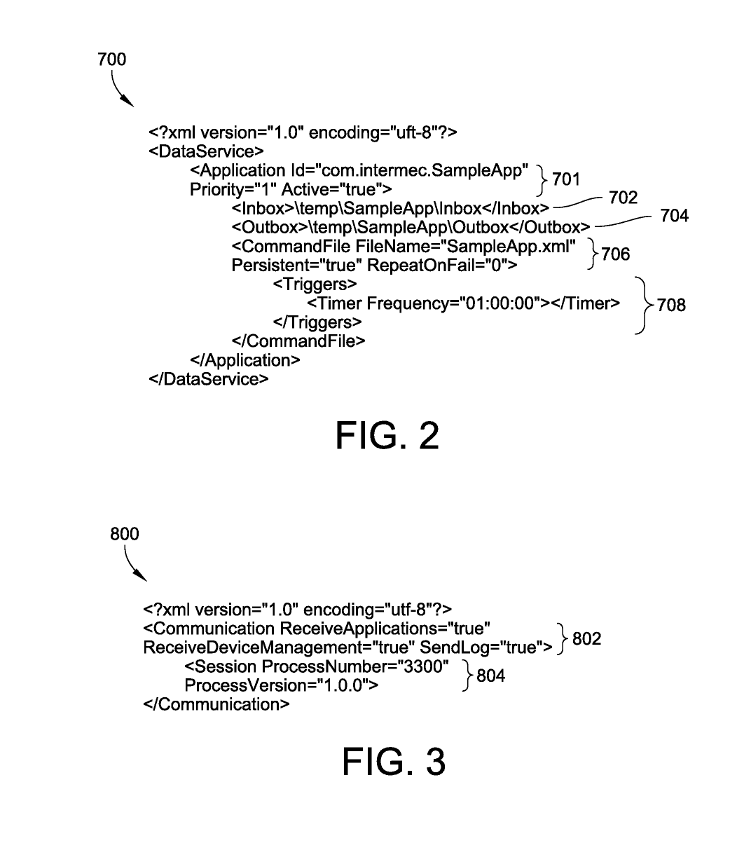

Referring now to FIG. 2, an example of a configuration file 700 for the data service 606 is described. The configuration file 700 shown in this example is written in XML, though it will be understood that other text-based markup languages could be used.

At 701, the configuration file includes an “Application” tag, specifying attributes for the application called “com.intermec.SampleApp”. Additional attributes may also be specified, such as that SampleApp has a priority of “1” and is active.

At 702, the configuration file 700 uses an “Inbox” tag to inform the data service that the inbox directory for the SampleApp is “\temp\SampleApp\Inbox”. At 704, the configuration file 700 uses an “Outbox” tag to configure the data service to use “\temp\SampleApp\Outbox” as the outbox directory for “SampleApp”.

At 706, the configuration file 700 uses a “ComandFile” tag to indicate to the data service that the command file for SampleApp is named “SampleApp.xml”. As before, additional attributes can be specified—for example, that the command file is persistent (i.e., it should remain in the outbox folder, and be executed whenever its triggers cause it to be activated), and that it should not be repeated if it fails.

At 708, triggers for the command file “SampleApp.xml” are optionally specified. In the example configuration file 700, the command file is triggered on a timer with a frequency of 1 hour. Thus, the command file “SampleApp.xml” will be executed at one hour intervals by the data service. Other possible triggers could be specified using other tags. The other triggers may include, for example, triggers that cause the command file to be executed when a specified file or files appear in a defined folder on the device, or when a push message with a defined message code and message data is delivered to the device.

There are many benefits from an extension of the trigger options that force data exchanges to take place automatically. These triggering of automatic communications may be based on a broad range of events, including device status and location. For example, a trigger may be based on a device location. In this case, a device entering into or out of defined zones (e.g., based on GPS coordinates), could trigger an automatic upload of all data from the device followed by a device wipe. In another scenario, the trigger could be a device health event, such as a low battery threshold or insufficient memory threshold being reached which could trigger an automatic communications session that would send the device identification information together with device location, the health problem, etc. to a central help desk for proactive support.

Although a specific syntax based on XML is shown for the configuration file 700, it will be understood that any predefined syntax can be used to configure the data service. XML provides a convenient framework for a syntax, since it is a well-known standard for structured markup languages, and is readily extensible. Of course, xml is used only to structure the file, and the tags used, etc. are not part of a standard.

FIG. 3 shows a short example of a command file 800 for use by a business application in sending commands to the data service. As with the configuration file described above with reference to FIG. 7, the command file 800 uses a syntax based on XML. Of course, as before, another pre-defined syntax could be used to communicate commands between a business application and the data service.

At 802, a “Communication” tag is used to instruct the data service to initiate a communication session. The “ReceiveApplications” attribute is used to specify that the data services should download new business applications when the communication session is started. The “ReceiveDeviceManagement” attribute is used to specify that the data service should download any device management software updates (if they are available), such as new versions of the data services client software, or device drivers. The “SendLog” attribute specifies that the client should send the client log to the server. Of course, these are only example attributes that might be used, and further attributes could be defined.

At 804, a “Session” element is used to specify the plug-in process number and plug-in process version with which the data service should communicate. Generally, the data service on the client device will communicate with a data plug-in on the server side or with other plug-in processes and versions.

The example command file 800 might be used, for instance, by a business application to periodically (e.g., using a “frequency trigger”) check for updates to business applications and system software and to download any such updates.

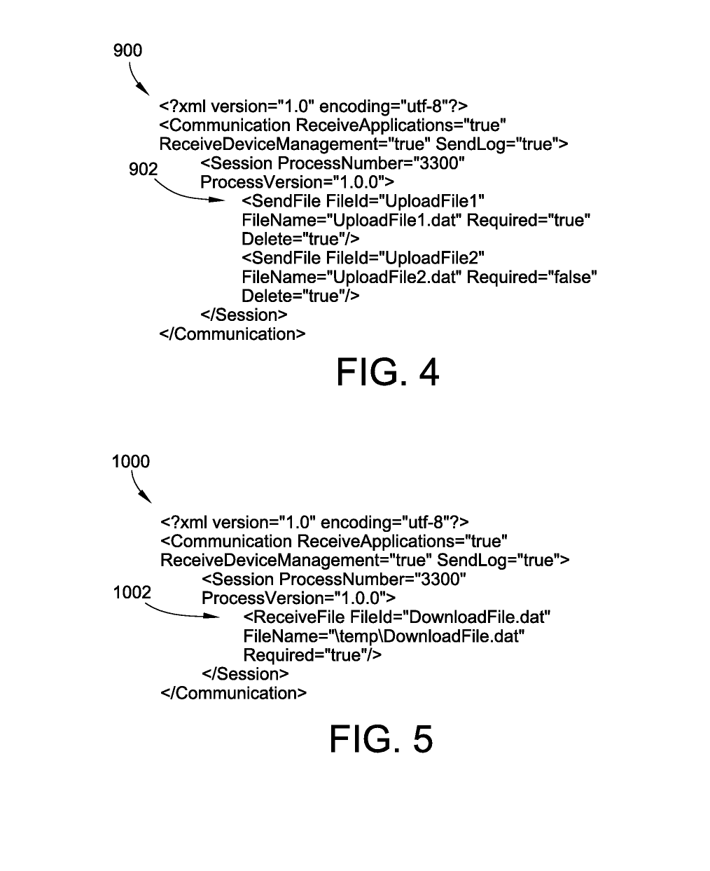

FIG. 4 shows another example command file 900 that sends files across the network to the server (i.e., to the data service plug-in, which will then distribute the files). The data service is instructed to send a file using a “SendFile” element, as shown at 902. The “SendFile” element includes attributes that specify a file ID (“UploadFile1”, in the SendFile element 902), the file name (“UploadFile1.dat” in 902), whether the file upload is required, and whether the file should be deleted from the client after being sent. Of course, other attributes may also be defined for use with a “SendFile” element.

Generally, a “SendFile” element will cause a specified file to be taken from the outbox directory, and be sent to the server. The command file 900 instructs the data service to send the files “UploadFile1.dat” and “UploadFile2.dat” to the data service plug-in on the server side. Because the upload of “UploadFile1.dat” has the “Required” attribute set, if the upload of “UploadFile1.dat” fails, then the data service will abort processing of the command file, and “UploadFile2.dat” will not be sent. Because the “Delete” attribute is set for both files, successfully uploaded files will be deleted from the device.

FIG. 5 shows another example command file 1000, that instructs the data service to receive a file from the server (i.e., from the data service plug-in on the server). The command file 1000 instructs the data service to receive the file “DownloadFile.dat” from the data service plug-in process on the server. The received files will generally be stored in the inbox directory on the client, but as shown in the command file 1000, other locations may also be specified.

At 1002, the command file uses a “ReceiveFile” element to receive a file from the server. The “ReceiveFile” element includes attributes that specify a file ID (“DownloadFile.dat” in 902), the file name including the path (“\temp\DownloadFile.dat” in 902), and whether the file upload is required. Of course, other attributes may also be defined for use with the “ReceiveFile” element. It will also be noted that the file path for the received file may be specified, and can specify directories other than the inbox directory.

FIG. 6 shows another example of a command file 1100. The command file 1100 instructs the data service to send files to the data service plug-in on the server in one batch. When the batch of files is successfully uploaded, the “UploadDone.txt” file is sent. This file signals to the plug-in on the server that uploaded files can be processed. If uploading of “upl_file_{—}1.dat” or “upl_file_{—}2.dat” files fails, the “UploadDone.txt” file will not be sent and processing of the command file results in an error.

At 1102, this is accomplished by a “SendBatch” element. The SendBatch element has the “Required” attribute set, so if the SendBatch element fails, then the data service will stop processing the command file 1100, and the “SendFile” element at 1110 will not send the “UploadDone.txt” file to the server. At 1104, a first file of the batch of files to be uploaded is specified in a “File” element, which specifies that the name of the first file is “upl_file_{—}1.dat” (which will be found in the outbox directory, since no path is specified), and that the file is required (i.e., if the upload fails, then the SendBatch element will fail). At 1106, a second file of the batch of files to be uploaded is specified in a “File” element, which specifies that the name of the first file is “upl_file_{—}2.dat”, and that the file is required. At 1108, a third file in the batch is specified, having the file name “nice-to-have-uploaded.dat”. For this third file in the batch, the “Required” attribute is set to “false”, so if the upload of this file fails, the SendBatch element can still succeed, and processing of the command file can continue. Finally, at 1110, if the “SendBatch” element was successful, a “SendFile” element, as described above, is used to send the “UploadDone.txt” file to the server, signaling that the batch upload is complete, and the files can be processed on the server.

FIG. 7 shows a further example of a command file 1200. The command file 1200 instructs the data service to receive files from the data service plug-in on the server in one batch. When the batch of files is successfully downloaded, the “DownloadDone.txt” file is sent. This file signals to the plug-in process on the server that downloaded files were successfully processed by the data service. If downloading of “dpl_file_{—}1.dat” or “dnl_file_{—}2.dat” files fails, the “DownloadDone.txt” file will not be sent and processing of the command file results in an error.

At 1202, a “ReceiveBatch” element is used to specify to the data service that a batch of files is to be received. A “FilePath” attribute is used to specify that the files are to be stored at the path “\temp\download”, and a “Required” attribute is used to specify that if the ReceiveBatch element fails, then the data service will stop processing the command file 1200, and the “SendFile” element at 1204 will not send the “DownloadDone.txt” file to the server. File elements are used to specify that three files—“dnl_file_{—}1.dat”, “dnl_file_{—}2.dat”, and “nice-to-have-downloaded.dat” are to be received. On the first two of these files, a “Required” attribute is set, indicating that if the download fails, then the ReceiveBatch element will fail. On the third file in the batch (the appropriately named “nice-to-have-downloaded.dat” file), the “Required” attribute is set to “false”, so that if the download fails, the ReceiveBatch element will still succeed. At 1204, if the “ReceiveBatch” element was successful, a “SendFile” element, as described above, is used to send the “DownloadDone.txt” file to the server, signaling that the batch download completed successfully.

It will be understood that in all of these examples, although XML is used for the command files, another pre-defined file structure and/or syntax could be used. Further, although the examples use specific command names for tags, elements, and attributes, these could also be changed such that different commands are used in the command files to instruct the data service.

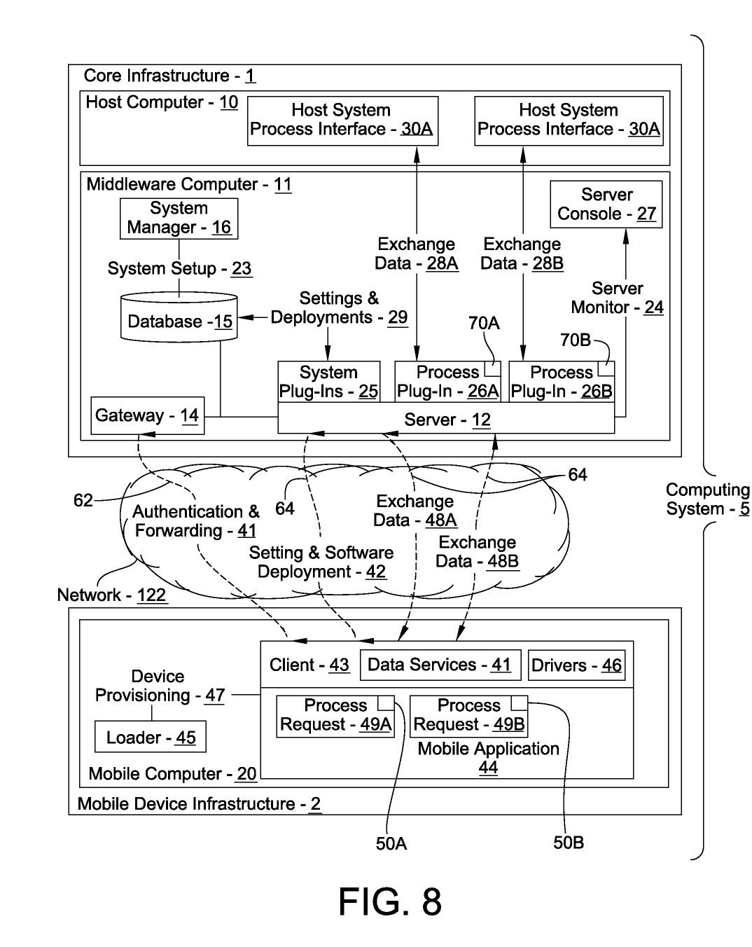

The foregoing has described the business application side of the shared data service and how the data service may be configured to accept commands from the plurality of mobile applications using a text-based mark-up language for communicating with a network for a process number. We now turn to the server side of the shared data service to describe how the shared data service establishes a connection between the requesting application and the network in accordance with a process identified by the configuration file; and how the data service initiates a connection with the network in response to the data exchange request for downloading a set of data associated with the requested process for configuring the data service in accordance with the process identified by the configuration file requested by the data exchange request from the requesting application. We also turn to how the requested process from the business application residing on the mobile computer configures the data service to establish a connection between the requesting business application and the network based on a priority rule and how one connection between the shared data service and the network may serve two or more communication sessions between one or more business applications and the network via the shared data services if the priority rules permit. To understand these and other aspects of the server side of the shared data service, it is important to understand an illustrative system in which the shared data service may be used and how the shared data service may communicate with that system. As discussed herein, the term “computing system” generally makes reference to computers (and other components, as appropriate) equipped with functionality (e.g., appropriate software) for implementing the teachings disclosed herein. Referring now to FIG. 8, there is shown a configuration of a computing system 5. In this embodiment, the computing system 5 includes a core infrastructure 1. The core infrastructure 1 includes at least one host computer 10, and at least one middleware computer 11. The core infrastructure 1 is adapted for communicating with a mobile device infrastructure 2 through the network 122. Generally, the mobile device infrastructure 2 includes a plurality of mobile computers 20. Mobile computers may include but are not limited to hand held computers, tablet computers, notebook computers, PDA, smartphones, and any other portable computing device useful for participating in data exchanges with servers, networks, and other components of computing systems.

It should be recognized that unless otherwise specified, the computing system 5 may include more than one of any of the components introduced herein. For example, in a large enterprise, it may be appropriate to include a plurality of servers 12. Accordingly, unless it is not feasible to implement a plurality of any given component, one should recognize that a plurality may be implemented.

Turning to the middleware computer 11 in more detail, it may be seen that the middleware computer 11 supports a few different aspects of the computing system 5. For example, the middleware computer 11 includes a gateway 14, a database 15, a system manager 16, a server 12 and a server console 27. Each of these components will be discussed further herein. Generally, the middleware computer 11 communicates with each of the mobile computers 20 through the network 122, which is accessed through at least one of the gateway 14 and the server 12. The mobile computer 20, in turn, operates a client 43 for enabling the communications. The client 43 interfaces with at least one mobile application 44, such as a business application, on board the mobile computer 20. More specifically, the client 43 allows computer system 5 to process data transfer requests from enabled business applications.

An introduction providing exemplary aspects of some of the components in the computing system 5 is now provided. In general, the gateway 14 is a server-side application that functions as an entry point into the computing system 5. The server 12 is a server-side application that accepts and handles requests 49 (49a, 49b) from a particular client 43. The server console 27 is a server-side application that provides a visual monitor of the communications processing within the computing system 5. A “remote-assist server” (not shown) is a server-side application that acts as a bridge between a remote assist console (not shown) and each client 43. The remote assist console may be a Microsoft Windows application (available from Microsoft Corporation of Redmond Wash.) that allows remote assist operators to collaboratively support users of the mobile device infrastructure 2. A “system monitor” is a server-side application that provides users with a visual indicator of the operating status of servers 12 and gateways 14 within a single implementation of the computing system 5. A process plug-in 26 (26a, 26b) is a server-side application that processes data exchanged for each request from a client 43. A system plug-in 25 is a special plug-in application that is used to perform system-level functions. A “test plug-in” (not shown) is an application that works with test client applications to verify connectivity and to test system performance for a given communications infrastructure. The system manager 16 is a server-side application that operates as a control center. A “packager” is a stand-alone application that provides for bundling files into packages.

The client 43 is a client-side application that provides for processing data transfer requests 49 from a mobile application 44. “Data services” 41 are a set of interfaces that provide mobile applications 44 with communications and data management functions as described in greater detail below and in application entitled “System and Process for Managing Network Communications” filed contemporaneously herewith. A device driver 46 is an application designed to work with a respective client 43 and control a specific type of mobile computer 20. A loader 45 is a client-side application used to register each mobile computer 20 with a specific computing system 5. The database 15 is a central structured repository that contains system configuration settings, such as settings that control how the computing system 5 operates. “SQL Server” is a separate application that handles requests from applications of the computing system 5 to access the database and retrieve or store information. SQL Server is a product of Microsoft Corporation of Redmond Wash. Also, in general, a “mobile business application” or simply a “mobile application” 44 is a software application that runs on a mobile computer 100 (also referred to as a “mobile device.”) Now consider some of the foregoing and other components in more detail.

The Gateway 14. The gateway 14 is a server-side application that functions as an entry point into the computing system 5. This application may run as a service in the operating system of a server-side computer 100, so it does not require a user interface. Each client 43 that submits a request 49 to establish a connection and exchange data 48 in the computing system 5 first connects to the gateway 14 for authentication and forwarding 41. The gateway 14 may also be used to implement push messaging features. The gateways 14 provide the direct push capabilities needed to deliver messages to clients 43 running on targetted mobile computing devices 20 that are accessible within the computing system 5. Push messages are a feature of the computing system 5 that allows the host computer 10 to initiate on-demand communications with a mobile business application 44, as opposed to having to wait for the mobile business application 44 to connect to a server 12. Push messaging provides for greater responsiveness and faster business process execution in a mobile device infrastructure 2.

The Server 12. The server 12 is a server-side application that accepts and handles requests 49 from the client 43 that are redirected from the gateway 14. The server 12 runs as a service in the operating system of a server-side computer, and hence does not require a user interface. Each mobile device 20 requesting exchange data 48 within the computing system 5 provides a process identifier 50 with each request 48-9 (called a “process number”). The process number identifies a particular process plug-in 26a, 26b that is used to handle the request 49 on the server 12. Each request 49 is redirected by the gateway 14 to the server 12 together with an associated process number. The server 12 then uses the process number to determine an appropriate process plug-in 26a, 26b to be invoked, thereby allowing the bidirectional flow of business data between the server 12 and the client 43 on the mobile computing device 20.

The Server Console 27. The server console 27 is a server-side application that is generally installed on the same computer 100 as the server 12. Because the server 12 runs as a service on the operating system and does not require a user interface, the server console 27 application may be used to provide a view into the operation of the server 12. The server console 27 provides a near real-time, continuous, read-only visual monitor of the communications processing taking place on the server 12. The server console 27 application allows observation of handling of communications by the server 12 during daily operations. The server console 27 application also provides a detailed view into data being transmitted within each communication session and therefore may be useful when seeking to identify a source of any connection or data management problems. Each mobile computer 20 requesting to exchange data within system 5 must provide with each of its requests an identifier of the process called a “process number” (not shown). The process number identifies the Plug-In process 26 that is to be used to handle the request on the server 12. The Plug-in process is a server side application that processes the data that is exchanged between computing system 5 and each client.

The Remote Assist Server. The remote assist server is a server-side application that runs as a service in the operating system of a server-side computer 100. The remote assist server acts as a bridge between the remote assist console application and the client 43 running on a given mobile device 20. Remote assists sessions are driven and controlled through the remote assist server. To use remote assist features in the computing system 5, this service must be active.

For implementations of the computing system 5 which utilize more than one server 12, it may be useful to install the server console 27 on a remote computer 100 (such as the desktop computer of the mobile computing system administrator) and then register each server 12 to that server console 27 so there will be a single point for server monitoring 24.

The Remote Assist Console. The Remote Assist Console is a Microsoft Windows based application that allows remote assist operators to collaboratively support users of the mobile communication system. Remote assist operators can, for example: remotely connect to and control multiple mobile devices 20; invite other operators to a remote assist session to collaborate and solve problems; initiate a connection to a mobile device 20 and remotely see and control a screen of the mobile device 20 without any interaction with the user; get and send files using standard Windows applications; record video or take screen shots of a remote assist session; as well as other similar tasks.

The System Monitor. The system monitor is a server-side application that provides a basic visual indicator of the operating status of servers 12 and gateways 14 within a single computing system 5. The system monitor application is generally installed on the same computer 100 as the system manager 16. However, the system monitor may be installed anywhere where a central monitoring dashboard for the computing system 5 is desired.

The Plug-In 26. The Plug-In application is designed to run on a server 12. Generally, the plug-in 26 is provided with a specific version of an enabled mobile business application 44. The system manager 16 loads Plug-In files into the computing system 5, which then stores these files and related information in the database 15. Based on the settings defined in the system manager 16, remote servers automatically extract Plug-In program files from the database 15 and install those files on a local computer 100. Each installed Plug-In program is then automatically called by the server 12 to process a specific request (identified by a unique process number) sent to it from a mobile business application 44.

The Plug-In 26 performs the processing of the business data that is exchanged for each request 49 from the client 43. Thus, the Plug-In 26 receives data associated with each request 49, processes the data in accordance with programmed business data processing logic and, in some embodiments, responds to the request 49. The processing performed by a Plug-In 26 is limited by, for example, needs of the developer, and resources in the computing system 5.

It is not required that each Plug-In 26 be dedicated to processing a single type of request 49. For example, the Plug-In 26 is not limited to processing requests 49 that are associated with only one process number. Thus, a single Plug-In 26 may support multiple process requests 49a, 49b (multiple types of requests from the mobile business application 44) with each process request 49 in the Plug-In 26 having its own unique process number. The extent to which process requests 49 to be handled are aggregated into a single Plug-In 26, or conversely the extent to which each Plug-In is atomized to handle only one specific process request 49, is discretionary.

It is not necessary that each Plug-In 26 run continuously on the server 12. Rather, a separate copy of the Plug-In 26 may be loaded into memory 250 and run each time the server 12 calls the Plug-In 26 to process a new request 49.

Essentially, the server 12 creates as many independent, virtual clones of a Plug-In 26 as is needed to manage all new incoming requests 49. The Plug-In 26 can exchange data 48 using any number of methods such as the transmission of a file, the direct manipulation of records in a database, interacting with a web service or parsing an XML document and executing a remote function call to a host system. Because the Plug-In 26 contains the intelligence to understand the data that is being passed to it, the Plug-In 26 can process the data in an event driven style, performing different tasks and starting and stopping different auxiliary systems based on the data and when it is received.

From the foregoing description, it is seen that the plug-in is a special program that is placed into memory by the server 12 when the server receives a request that a communications session be handled by that plug-in. The request illustratively calls for the plug-in by process number, a process name, or by some other form of identification. In addition, the process requested may be but one of a plurality of processes that may be encapsulated in a single plug-in. For example, a plug-in could be named “SAP Integration” and contain a first process, Process Number 1000, named “Submit New Order to SAP”, and a second process, Process Number 1250, named “Retrieve Inventory Status for Part No.” Each of these Plug-In Processes are essentially atomized chunks of business data processing and integration logic. As described herein, the system itself is agnostic to any business logic—it does not understand the data it transmits. However, a plug-in process, as mentioned above, can interpret the data sent to it, and for example, connect to an SAP ERP host system, use the data received from the mobile application to retrieve new data from SAP, and then hand that data back over to the server for delivery back to the mobile application/device (all within a couple of seconds). Note that the plug-in itself does not contain rules for routing the data etc. The way connections are established and data is routed, is a function of the way the client and the gateway/server communicate together, using their own protocol that is separate from the data being transferred and separate from the data services protocol.

As described above and further below, the plug-ins do not contains rules; that is to say, rules are not updated on plug-ins. Rather, the only thing that plug-in processes receive is input in the form of data that is routed to it through the system (through the client and server) from a mobile business application. A plug-in process can also reference the system code associated with the communication session to identify the user for whom the data exchange is being requested. In addition, the plug-in processes can also obtain as input the value of any plug-in properties that the administrator may have defined values for through the administrator application.

The System Plug-In 25. The System Plug-In 25 is a special type of application that is pre-installed with the server 12 and is used to perform system level functions. Exemplary system level functions include tasks such as deploying software packages to the mobile device 20 and remotely configuring the mobile device 20. The behavior of the system Plug-In 25 program is controlled by the configuration settings defined in the system manager application 16.

The Test Plug-In. The Test Plug-In program, available with each computing system 5, is designed to work together with Test Client applications. The Test Plug-In program may be used, for example, to verify communications connectivity, and test over-all performance of the computing system 5 within a larger communications infrastructure.

The System Manager 16. The system manager 16 is a server-side application that operates as a control center of the computing system 5. Just about everything that can be configured, tracked and managed in the computing system 5 may be accomplished through the system manager 16 application. Thus, the system manager 16 is an important application available to the administrator of the computing system 5.

In general, the system manager 16 is provided with a user-friendly, easy to navigate interface encompassing all modules and related configuration settings. The system manager 16 application may be installed on a separate desktop computer 100 or notebook computer 100, but may also be installed directly on the computer where other system components, such as the gateway 14, or the server 12, are installed and running

The system manager 16 application may also be installed on multiple computers 100 to provide a plurality of users with access to system information. Each person that is added as a user of the system manager 16 is automatically assigned “reader” rights within computing system 5. Reader rights means the user has a read-only view of all configuration settings, while users assigned “administrator” rights shall have an additional option to modify the configuration settings of each module within the computing system 5. Generally, changes to the configuration settings defined in the system manager 16 are valid in the computing system 5 from inception, and therefore these changes will immediately be reflected in the behavior of the computing system 5.

In some embodiments, more than one user at a time may be logged into the system manager 16 as an administrator. If an attempt to edit something in the system manager 16 is made while another user is already editing that same information, or information which has dependencies on the settings you are trying to modify, the system manager 16 will alert the user to a conflict.

The Packager. The Packager is a stand-alone application that allows you to bundle files into packages that can be loaded into the system manager 16 for automatic, remote installation to your mobile computing devices. These packages typically contain the files required to install a client 43, device driver 46 or a mobile business application. The Packager application allows a user to define where the files in a package will be installed, which files should be deleted from the mobile device, as well as modify registry settings in the operating system.

The Client 43. The client 43 is an application that is installed on each mobile device 20. The client 43 provides for processing of requests 49 from enabled mobile business applications 44, which may be hosted by any one of a number of device types including hand held computers 100, tablet computers 100, and notebook computers 100. The client 43 provides functionality at the level of the mobile device 20. In general, the client 43 includes one to many self-running mobile applications and DLL (Dynamically Linked Library) files that are installed on the mobile device 20. The client may also include other forms, including a library to be linked with the target mobile business application.

Executable files for the client 43 include functions that directly execute mobile communications. The executable files generally process in cooperation with the device drivers 46 to provide management of the mobile device 20. Functions of the client 43 may also be accessed programmatically from a mobile business application 44, such as via the data services component and associated interface components.

The functions of the client 43 are generally designed to automate steps required to establish a connection 62 between a mobile device 20 and the gateway 14, which may be followed by a connection 64 to a server 12, which will then allow for the reliable and secure exchange data 28 between the mobile business application 44 and the process Plug-In 26a, 26b. Therefore, the functions provided by the client 43 include those required to establish the connections 62, 64 to a gateway 14 and server 12 using a supported communications adapter on the mobile device 20, functions to manage the automatic exchange of data encryption keys, functions to perform the automatic compression and encryption of data sent by a mobile business application 44 over the connection 62, 64, as well as functions for receiving and installing new mobile business applications 44 (and new versions of device drivers 46 and the client 43 itself) whenever packages containing these files are loaded centrally into the system manager 16.

The client 43 also performs changes in the configuration settings of the mobile device 20 based on how the device's property settings are defined in the system manager 16. Furthermore, the client 43 may perform dynamic selection of an appropriate connection path 62, 64 to be used between the mobile device 20 and a gateway 14 / server 12 based on communication rules defined centrally in the system manager 16. Additionally, the client 43 may collect and transmit back to the server 12 all information regarding the operation of the client 43, as well as events logged by the mobile business application 44 and changes made to settings of the mobile device 20 so that this information may be viewed in log modules of the system manager 16.

Data Services. Data services of the computing system 5 generally include a set of interfaces that provides for mobile business applications 44 to use communications and data management functions. The data services are included in a client-side executable file, and are part of the client 43. A data service Plug-In is the server-side counterpart of the data service on the client 43.

Mobile business applications 44 can register themselves to use the data services by storing a configuration file in an application folder on the client 43. After an application 44 is registered to use the data services, the application 44 can use data service command files to upload and download data (48), which provides for leveraging features of the computing system 5 without having to use low level programming interfaces.

The Device Driver 46. Each device driver 46 includes an application that is designed to work with the client 43 and control a specific type of mobile device 20. Device drivers 46 may be published, for example on the Internet 121, and downloaded as needed. Device drivers 46 so obtained may be installed into the computing system 5 to provide that system with the ability to manage new types of mobile devices 20. New and updated device drivers 46 may be installed in using the system manager 16. When a new device driver 46 is installed, the system manager 16 reads the associated information file for the device driver 46 and uses this information to create new entries in the database 15. Entries in the database 15 show that a new type of mobile device 20 is now supported in the computing system 5, and any configuration properties that may be used to remotely modify and retrieve settings for the new mobile device 20.

The Loader 45. The loader 46 is an application that is installed on the mobile computing device the first time it is put into use. The loader 45 application is used on the mobile device to register that device to a specific computing system 5. After the registration has been processed in the system manager 16 by an authorized administrator, the loader 45 can connect to a gateway 14 and server 12 for the first time. The loader 45 will automatically download and install to the mobile device the latest versions of the appropriate software packages: the client 43, device driver 46s, and a mobile business application as well as retrieve the device settings defined for it in the system manager 16 and call on the device driver 46s to configure the mobile computing device and all peripherals in the device set. After an enabled mobile business application is installed, this mobile application and the client 43 will cooperate to perform any future software updates on the mobile device as well as update device settings. Therefore, the loader 45 is needed only at the beginning when a new mobile device, or fully reset mobile device, having only an operating system installed, is to be provisioned for use.

The Database 15. The database 15 is generally located on a server-side computer 100. In some embodiments, the database 15 runs on SQL Server (available from Microsoft Corporation of Redmond Wash.). Generally, the database 15 is the central structured repository of computing system 5 configuration settings that control how a given computing system 5 will operate. The database 15 also stores log transaction information that is created within the computing system 5, all software packages available for distribution to mobile devices 20, and all Plug-In (25, 26, test) programs available within the computing system 5. The database 15 may be automatically created, such as during the initial steps of installation of the computing system 5, such as by using a system setup 23 application for the database 15.

Microsoft SQL Server. Components of the computing system 5 operate according to the configuration settings defined in the system manager 16 and stored in the database 15. The Microsoft SQL Server application, which is itself not a component of the computing system 5, handles requests 49 from applications of the computing system 5 to access the database 15. Therefore, the computing system 5 includes access to a properly configured and operational Microsoft SQL Server application and the database 15. Of course, the use of Microsoft SQL Server is merely illustrative and is not limiting of the teachings herein.

Mobile Business Application 44. The mobile business application 44 (or simply “mobile application” 44) is a software program that runs on a mobile device 20. The mobile application 44 is not a component of the computing system 5, per se, even though it can be designed to interact closely with computing system 5 (such as via the client 43) and is a part of a complete mobile business system solution. The mobile application 44 may be directed to anything desired by users, developers and the like. The mobile application 44 may serve the needs of a particular industry or organization, it may be simple and require only regular batch transfers of data, or it may be complex and require many different types of on-line data exchanges 48. Mobile business applications provide users with the business level functions needed to perform their work, such as taking an order, issuing an invoicing, or documenting a service incident.

These applications may be as simple or as complex as is warranted by the business processes they are designed to support. The enabled mobile business applications are designed to work together with the client on the mobile computing device, thereby leveraging the device management, data management, communications management and communications security features that are an integral part of without having to custom develop and maintain this wide-scope of generic functionality, for each mobile computing system solution that is implemented.

In order to understand how the client 43 and the data service 41 and the business applications 44 on the mobile computer 20 initiate and communicate with the network 1 using process numbers, an introduction providing exemplary aspects of some aspects of the network which contribute to the communications between the business applications and the network and the protocol used for those communications is provided. As previously indicated, the gateway 14 is a server-side application that functions as an entry point into the system. A client 43 that requests to establish a connection process as discussed below and exchange data in computing system 6 must first connect to the gateway 14 for authentication. After the gateway 14 has determined the validity and access rights of the connecting mobile computer 20, the gateway redirects the requests coming from the client to the server 12, based on the identifier of the system plug-in process 25 being requested and the current processing load of each computer presently running a server.

Communication Processes. A communication process is the uniquely identifiable request for an exchange of data that is initiated by the mobile business application 44 via the client 43 on the mobile device 20 and transmitted to and possibly responded to by plug-in 26 running on the server 12. The contents of the communications process, or simply “process” for short, may be anything the developers of the mobile application and the plug-in program agree to exchange. This means that so long as the mobile application and plug-in are both “aware and synchronized” with respect to how the data that is being sent by each side should be processed and responded to by the other side, the actual data transmitted is entirely up to these applications, and is in no way constrained by the system.

The system will support any and all data transfers with virtually any mobile application and any host system. The data can be text, XML formatted, binary, etc. It can also be pictures, movies, GPS data, device health monitoring data, as well as any other form of business or personal data. Hence, the plug-in may include data of a business or personal or other kind in a wide variety of formats including text, XML, binary, or other format.

Process numbers 50 are assigned and used by mutual agreement between the developer of the mobile application and the developer of the plug-in program—process numbers are embedded in these cooperative programs and are not modifiable using the manager 16. To install the plug-in program 26 using the manager 16, the plug-ins associated PLI file (plug-in Information file) which contains the information needed to install the plug-in, such as process numbers, process versions, process properties, process descriptions etc. is selected and stored by the manager 16 in the database 15 together with a binary copy of the plug-in program 26. The plug-in program is installed automatically on the server 12 as a result of having one of the processes that it supports assigned to that server, the assignment being controlled by the manager 16. Using the manager, selected settings can then be modified for the plug-in 26 as well as assignments made of the connection paths that may be valid for each of the processes which the plug-in can handle. Based on this information, the gateway 14 and the server 12 are able to properly route each process requested by a mobile application 44 to the plug-in 26 responsible for managing that process.

While the process may be as simple as uploading a file from the mobile device 20 to the server side computer, a process can also be much more complex. For example, it can involve a series of integrated requests and responses such as when a person uses a mobile application to interrogate an ERP application on-line over a GPRS connection to check the stock status of an item or post a new customer order and schedule product deliveries.

The method by which a request for the exchange of data, initiated by the mobile application 44, is routed in the system to the appropriate server and plug-in for processing, is a function of the unique identifier of each process (the process number 50), the connection paths 62, 64 that is defined in the manager 16 and the gateway 14, the server 42, and the client applications 44 that run the core of system. As disclosed below, the “process number” 50 and the “connection path” 62, 64 define how data is routed between applications—that is, from a mobile device to the server side computer 62, 64.

In the system each process requested by the mobile application 44 is identified by its process number 50. Each requested process number 50 must coincide with a process number 70a, 70b that is coded inside the plug-in that is called by the server on which it is installed. The plug-in is responsible for managing the incoming process request from the mobile application (receiving the data, processing the data as needed and responding to the received data as expected according to the data exchange interface agreed upon between the developers of the mobile application 44 and the plug-in 26).

Each plug-in can support one or more processes based on the process numbers 70 encoded in the plug-in itself. The manager 16 serves as an administrator to view which plug-in 70 is installed on which server as well as the type of processes each plug-in supports and their process numbers. Moreover, the gateway application 14 which is responsible for authentication and redirection of the client 43 request to the server application 12, determines which servers are able to manage the incoming process by looking at the process number 50 sent by the client 43 and comparing it to the process number coded in each plug-in 26 that is registered in the database 15 together with the servers 12 on which it is available.

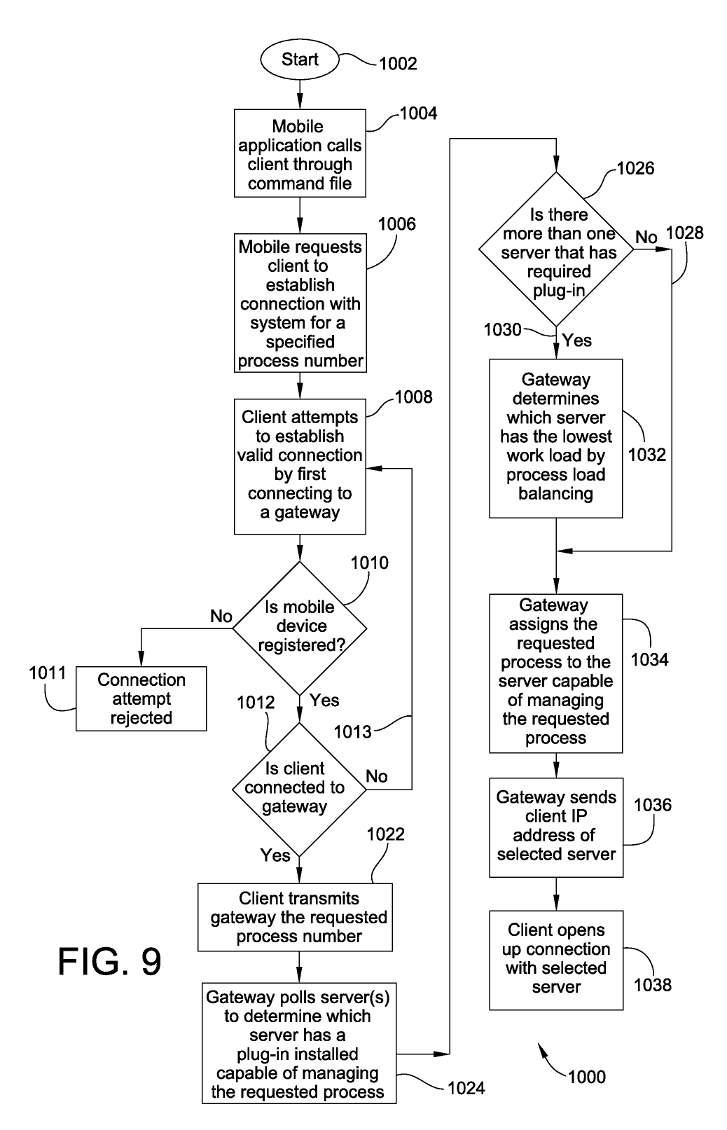

As an illustrative example of the process by which the business applications communicate with the network through the data service, FIG. 9 shows a client request of a network 1000 to establish a valid connection to the network. The process starts at step 1002. As indicated, at step 1004 the mobile application (44 in FIG. 1) that will exchange data with a server side computer (12 in FIG. 1) calls the client (43 in FIG. 1) through an XML interface of the data service (command file) (not shown). At step 1006, the business application (44 in FIG. 1) requests from the client (43 in FIG. 1), via the client XML command file, to establish a connection to system (core infrastructure 1 in FIG. 1) for a specified process number. When the client (43 in FIG. 1) receives a request for a particular process number, from the mobile application (44 in FIG. 1), at step 1008, the client attempts to establish a valid connection to system (core infrastructure 1 in FIG. 1) by first connecting to the gateway (14 in FIG. 1) and transmitting to it the requested process number (50 in FIG. 1). The connection may be by LAN, WiFi, GPRS, or other manner of communication. In this example, it is noted that the business application is signaling the client to initiate the communication with the host system. However, the host system (10 in FIG. 8) may also signal the client to initiate a communication session with the client by use of push technology as further described below.

At step 1010, the gateway determines if the mobile device has been registered. If the mobile device has not been registered, the process advances to step 1011 where the connection attempt is rejected. If the device has been registered, the attempt to connect is permitted.

A prerequisite to using the disclosed system is that the mobile device be registered with the gateway. Part of that registration process is the acceptance by the network manager of the request from a mobile device to register. Once registered, the manager assigns the newly registered mobile device appropriate device set templates for provisioning with appropriate device settings for use in the disclosed network communications. Particulars on how a device setting may be used in the management of network communications can be found in application entitled “System and Process for Managing Network Communications” filed contemporaneously herewith which is incorporated herein by reference.

As previously indicated, if the device has been registered, the attempt to connect is permitted and the mobile device can attempt to make a connection with the gateway. At step 1012, if the client is unable to get connected to the gateway, the client returns to step 1008 to attempt to establish a valid connection to the gateway. Once the client establishes a valid connection to the gateway at step 1012, the client transmits to the gateway the requested process number. At step 1024, the gateway polls the servers to determine which servers has a plug-in installed that is capable of managing the requested process. At step 1026, the gateway determines if there is more than one server that has the required plug-in. If the gateway determines that there is only one server that has the required plug in, the process advances to step 1034 where the gateway assigns the requested process to the server having the required plug-in. If at step 1026, the gateway determines that there are more than one server having the required plug-in, the process advances to step 1032 determines which server has the lowest work load by a process of load balancing as described in FIG. 3. At step 1034 the gateway assigns the requested process to the server capable of managing the requested process. At step 1036, the gateway forwards to the client the IP address of the server that the gateway has assigned to manage the communication with the client. At step 1038, the client opens up a connection with the selected server. It is the gateways assignment of the management of the process to server at step 1034 and the forwarding of that IP address of the server to the client that allows the client to open up a connection with the selected server in step 1038. In a private network, the gateway will forward the IP address of the server directly to the client. In a public network, the provisioning of the client with the IP address of the selected server is described in greater detail below.

As previously discussed, the device driver 46 is an application designed to work with a respective client 43 and control a specific type of mobile computer 20. The device driver enables the client to interact with the mobile computer supported by the driver. The driver application is not registered; rather the client can capture unique information about the mobile computer (e.g.,. its serial numbers) and submit those device identification credentials to the network where they can be accepted or denied by the administrator. Mobile computers that are successfully registered in the system, that is to say, approved by the administrator, can be provisioned for use and begin to exchange data. In this way, the gateway (14 in FIG. 1) uses the process number (50 in FIG. 1) to determine the appropriate server (12 in FIG. 1) to which the given client may be directed. The gateway determines which server should be used by the given client by determining which servers have a plug-in installed that is capable of managing the requested process, and also taking into consideration which one of these servers presently has the lowest work load according to a load balancing process as explained below.

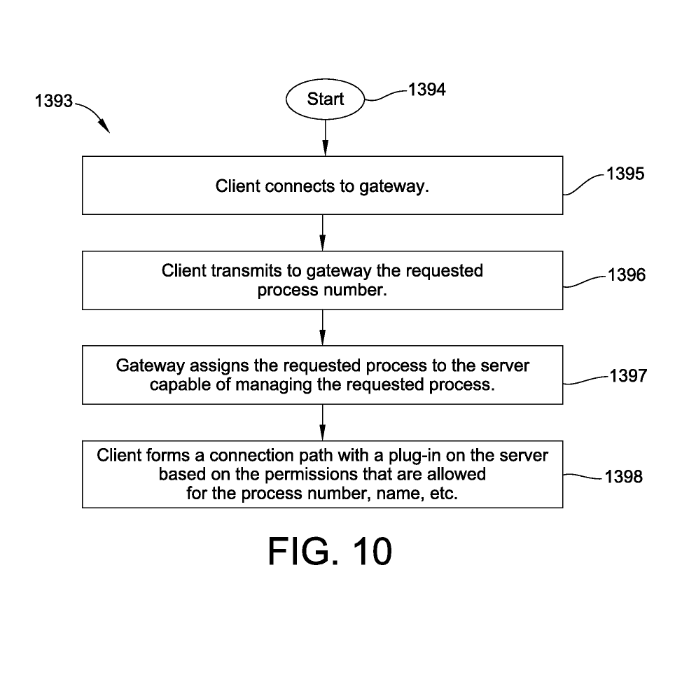

FIG. 10 shows the process 1393 by which a communication path or channel is established between the client (43 in FIG. 8) and the system (1 in FIG. 8). The process starts at step 1394. At step 1395, the client establishes a connection with the gateway (14 in FIG. 8) after initiating a session with the gateway, provided the mobile device has been properly registered client with the system as previously discussed. At step 1396, the client transmits to the gateway the requested process number. At step 1397, the gateway assigns the requested process to the server (12 in FIG. 8) capable of managing the requested process. (see step 1034 in FIG. 9) At step 1398, client forms a connection path with a plug-in on the assigned server to manage the process requested by the client for the purpose of establishing the process requested by the client based on the permissions that are allowed for the process.

From the above description, the connection path is seen to be established from the client on the device to the plug-in process, running on a server. The plug-in process is identified by a process number (but could also be by a process name, etc.) which contains the logic to receive, interpret, transform, and respond to the data sent by the client (on behalf of the mobile business application). The plug-in process may also connect to other server-side host systems to submit data or retrieve additional data requested by the mobile business application. Connection Path Timing

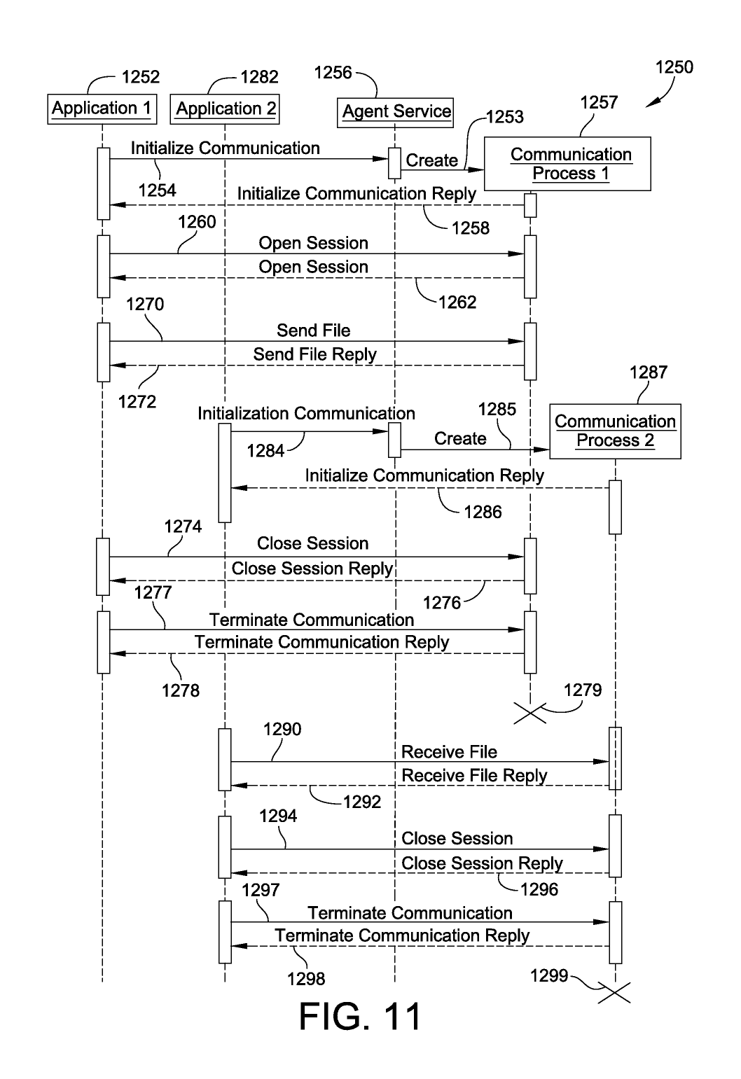

An example of the process for setting up and managing the connection paths is shown in FIG. 11. More specifically, FIG. 11 illustrates a timing diagram for establishing communications between various mobile applications 1252, 1282 and the servers (12 in FIG. 8) of a computing system (5 in FIG. 8). FIG. 11 therefore shows a server 12 and a gateway (14 in FIG. 8) performing certain actions in conjunction with two mobile applications 1252, 1282 via a single data service 1256 (of a client 43 in FIG. 8) which is shared there between. In some cases the mobile device (20 in FIG. 8) and/or the client thereof is configured so that all business applications 1252, 1282 on the mobile device must route all of their process requests through the data service 541. The computing system 505 of embodiments can also be configured to help enforce the routing of all data exchange requests through the data service 1256 through, perhaps, refusing to establish communications from any other source.

FIG. 11 shows in greater detail the system setup and management of connection paths. FIG. 11 illustrates aspects of establishing communications within a computing system. More specifically, FIG. 11 illustrates a timing diagram for establishing communications between various mobile applications 1252, 1282 and the servers (12 in FIG. 8) of a computing system (5 in FIG. 8).

FIG. 11 shows a server (12 in FIG. 8) and a gateway (14 in FIG. 8) performing certain actions in conjunction with two mobile applications 1252, 1282 via a single data service 1256 (of a client 43 in FIG. 8) which is shared there between. Indeed, in some cases the mobile device (20 in FIG. 8) and/or client thereof is configured so that all business applications 1252, 1282 on the mobile device must route all of their process requests through the data service. The computing system of embodiments can also be configured to help enforce the routing of all data exchange requests through the data service 1256 through, perhaps, refusing to establish communications from any other source.

FIG. 11 illustrates mobile application 1252 initiating a communication request by, for instance, requesting that a particular process be executed by the server. See reference 1254. The data service 1256 receives the request from the mobile application 1254 and, routes it (along with the applicable process number) to the gateway. More specifically, the data service 1256 determines which type of connection is appropriate (based on the process number and priority) and makes its own communication request over an appropriate connection. See reference 1253. The gateway subsequently selects a server for handling the process request. At reference 1258, the selected server returns a reply to the request to initialize communications by the mobile application 1252 to that mobile application over the connection selected by the data service 1256.

With communications thereby established, the mobile application 1252 opens a session with the server (with the aid of the data service 1256 in some embodiments). See reference 1260. Responsive thereto, the server sends a reply acknowledging the opening of the session as illustrated by reference 1262. When the mobile application 12252 is ready to receive the data from the pertinent process, it sends a request for a data exchange (and/or file) within that connection. See reference 1270. The server, responsive thereto, executes the requested process and sends the resulting data at reference 1272.

At some point it might be the case that mobile application 1282 requests that a process be initiated so that it too can exchange data with some server of the computing system. Reference 1284 illustrates such a process request. The data service 1256 again determines which type of connection is indicated by the requested process number and the priority of the connection type. It then establishes a connection of the indicated type over a connection of the indicated type and forwards the process request and number to the gateway. See reference 1285. The server selected by the gateway sends a reply acknowledging the request to the business application 1256 thereby establishing a connection (with, in some embodiments, the aid of the data service 1256). See reference 1286. Note that, if circumstances warrant it, the exchange with the mobile application 1256 could result in either a brand new connection or a new session within the connection already established with mobile application 1252 as further below. In the current scenario it can be assumed that a new session is created within the existing connection. That is, the existing connection is of a type suitable for the process requested by mobile application 1282. However, it could also be the case that the data exchange with mobile application 1282 occurs by way of an other session even though this is not illustrated.

With continuing reference to FIG. 11, at reference 1274, the mobile application 1252 could close its session with the server. Reference 1276 illustrates the server sending a reply acknowledging the closure of the session. If all such sessions between mobile application 1252 and the server are closed, mobile application 1252 can send a message to the server indicating that communications are to be terminated with it. See reference 1277. At reference 1278 the server can acknowledge the termination of the communication with the mobile application 1252. Such an exchange ends the communications between the mobile application 1252 and the server in the current scenario. But the ending of the session with mobile application 1252 advantageously does not end the connection that exists between the data service 1256 since the data service, and not the mobile application is controlling that session on the client-side and so the control of that connection is in the hands of the data service and not the mobile application. This control enables more efficient use of connections between the network and the mobile device which leads to more efficiencies and better management of mobile devices on the network.

The other mobile application 1282, in the meantime, could have reached a condition in which its programming indicates the desirability of receiving a file from the server in which it is in communication. It therefore sends a message to the server indicating that the requested process should execute so that it can receive the file. See reference 1290. Responsive thereto, the server can send a reply (with, perhaps, the requested file) at reference 1292.

Furthermore, once the requested file is received (or the requested data exchange ends), the mobile application 1282 and the server can close the session through which they have exchanged that data. See references 1294 and 1296. If, moreover, all sessions over the connection between the mobile application 1282 and the server are thereby closed (and all other sessions on that connection are closed), the mobile application 1282 and the server can terminate communications and/or close that connection. See references 1297 and 1298.

In the previous illustrative example, the term “File” was used. It should be noted that the term “File” as used in this example does not need to be a file in the conventional sense of the term, but more generally speaking it is “Data”. For example, the “Data” may be data that is transmitted between a host system and a mobile business application, through the disclosed system, that may only be kept in memory as an array and never actually take the form of a file in the classical sense. Hence, in more real time operations via HTTP, web services, etc., the disclosure is not limited to classical files being transmitted but more generally may include streaming data in a dialog between the mobile business application and host system, via the disclosed system.

Having thus introduced aspects of the computing system 5, further detail of specific aspects of the data service system and process of this disclosure are now introduced.

### Data Service System and Architecture

In the computing system 5, each process requested by the mobile application 44 is identified by its process number 50. Each requested process number must coincide with a process number that is coded inside the plug-on 26 that resides on one or more server 12 on which it is installed. The plug-in 26 is responsible for managing the incoming process request from the mobile application 44 (receiving the data, processing the data as needed and responding to the received data as expected according to the data exchange interface agreed upon between the developers of the mobile application 44 and the plug-in 26).

Each plug-in 26 can support one or more processes based on the process numbers 50 encoded in the plug-in 26. The system manager 16 determines whether a given plug-in 26 is to be installed on a given server 12 as well as the type of process request 49 supported by each plug-in 26, as well as the respective process numbers 50 that are to be associated with the plug-in. Moreover, the gateway 14 application which is responsible for authentication and redirection of the client 43 request to the server 12 application, determines which servers 12 are able to manage the incoming process by looking at the process number sent by the client 43 and comparing it to the process number coded in each plug-in 26 that is registered in the database 15 together with the servers 12 on which it is available.

In practice, the mobile application 44 that will exchange data with a server side computer must request from the client 43, via an API function, a call for the client 43 to establish a connection for a specified process number. When the client 43 receives the request for the particular process number from the mobile application 44, it attempts to establish a valid connection to the computing system 5 by first connecting to the gateway 14 and transmitting to it the requested process number. The gateway 14 uses this process number to determine the appropriate server 12 to which the given client 43 will be redirected. The gateway 14 determines which server 12 should be used by the given client 43 by determining which servers 12 have a plug-in 26 installed that is capable of managing the requested process request 49, and also taking into consideration which one of these servers 12 presently has the lowest work load as described application Ser. No. ______ entitled “Communication Protocol and System for Network Communication” filed contemporaneously herewith and incorporated herein by reference.

Process numbers 50 are assigned and used by mutual agreement between the developer of the mobile application 44 and the developer of the plug-in 26 program. That is, process numbers are embedded in these cooperative programs and are not modifiable using the system manager 16. To install a plug-in program 26 using the system manager 16, a PLI file (Plug-In Information file) associated with a plug-in 26 is selected. The PLI file contains the information needed to install the plug-in 26, such as process numbers, process versions, process properties, process descriptions etc. The system manager 16 will store this information in the database 15 together with a binary copy of the plug-in program 26. The plug-in program 26 is installed automatically on a server 12 as a result of having one of the processes that it supports assigned to that server 12, with assignment being controlled using the system manager 16. Using the system manager 16, selected property settings for the plug-in 26 may then be modified as well as assigned the connection paths that will be valid for each of the process requests 49 the plug-in 26 can handle. Based on this information, the gateway 14 and the server 12 are able to properly route each process requested by the mobile application 44 to the plug-in responsible for managing that process.

### The Connection Path

A connection path specifies the type of connectivity that can be used by the mobile device 20 to connect to the gateway 14/server 12 to exchange data with each process request 49. The process request is the request made by the mobile application 44 for the process number 50. In order for the mobile business application 44 to be able to request any given process number, a connection path through which that process number can be requested from the mobile device is first defined. In other words, every process number must have one or more connection paths defined for the communication between the business application 44 and the gateway 14/ server 12 that may result in the download the process from the plug-in. Connection paths are configured using the system manager 16 application. More specifically, the type of connectivity for each connection path can be defined by the manager, and is generally based on the types of network connectivity available on each mobile device 20 and supported by the computing system 5. Therefore, the mobile device 20 that has a built-in and supported GSM modem, Ethernet LAN adapter, and an 802.11 Wi-Fi radio has the ability to establish three different types of connections. Each process number 50 defined within the plug-in 26 that is assigned to run on the server 12 may also have assigned to it the type of connectivity that can be used by the client 43 when attempting to establish a connection from the mobile device 20 to request the given Plug-In process 26.

In addition, using the system manager 16, the times during which a particular connection path may be available for use by the client 43 may also be set. The type of connections available to the mobile application 44 and the time of day that the mobile application 44 may be able to establish a connection with the network thus form two powerful rules for managing the mobile computers 20 on the system 5. More rules are discussed below and further in Application S/N entitled “Communication Protocol and System for Network Communication” and Application S/N entitled “System and Process for Managing Network Communications” both filed contemporaneously and incorporated herein by reference. Together, these rules define when the client 43 may establish certain types of network connections for specific plug-in processes 26, thereby allowing which data (based on the process number) may be exchanged over which communication infrastructure and when such an exchange of data may occur to be controlled.

It is possible for more than one connection path to be made available for each particular process number with a priority set for each connection as may be defined by the system manager 16. When multiple connection paths with different priorities for a given process are defined in the system manager 16, the client 43 on the mobile device 20 may attempt to establish a connection for the requested process, in the order of connection path priority defined.

The following is an example of a set of rules that a manager 16 may assign to a plug-in that contains the process that the client may request by a process number. In this example, the process is the downloading of a large product catalog file to a mobile device. The mobile application may request this process by process number. According to the rule defined by the manager for this process, this process should not be allowed during specific times of the day. For example, the process is not allowed between 5 am and 6 pm, during normal working hours when an organization's communication infrastructure is already strained with routine business data transfers. The rule further requires that at the off-peak times when this process is allowed, the client must follow these connection path priorities—namely, first try to connect using the LAN adapter of the mobile device if a LAN connection is available since it is the most efficient, as a second best alternative try to connect using the 802.11 Wi-Fi radio in the mobile device if a Wi-Fi access point is available, and only as a third and least desirable alternative, try to connect using the GPRS radio in the mobile device.

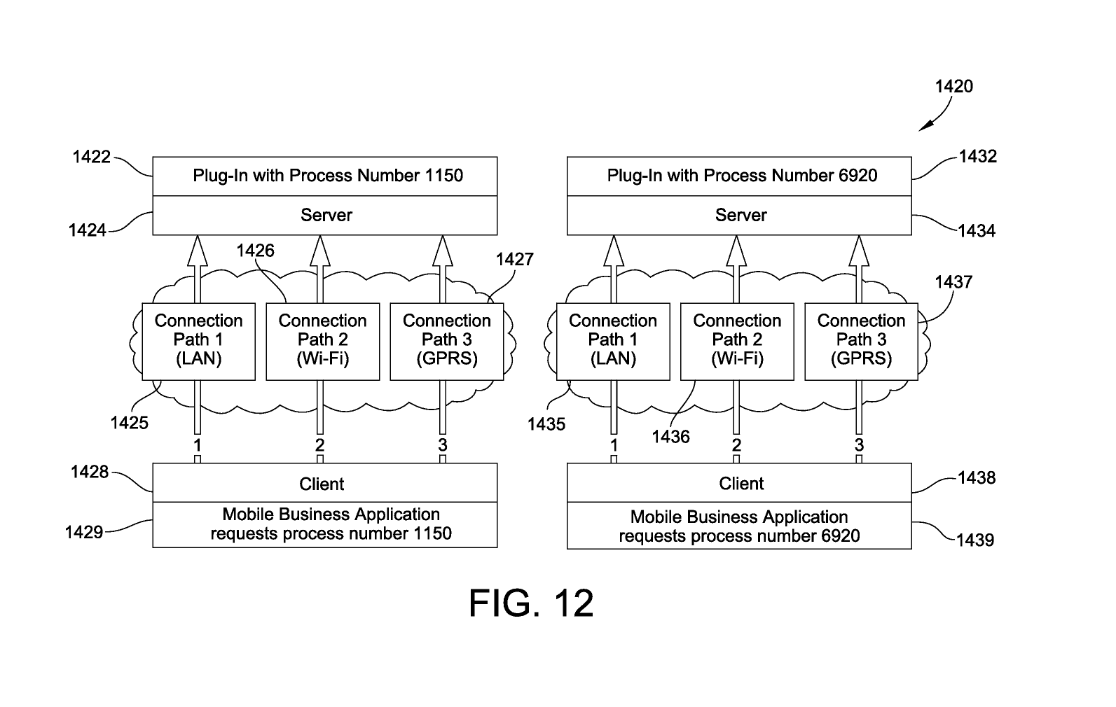

FIG. 12 shows the connection path scenarios for this example in a system 1420 that applies this rule to two plug-ins—a first plug-in with process number 1150 depicted as element 1422 and a second plug-in with process number 6920 depicted as element 1432. For the first plug-in 1422 with process number 1150, a server 1424 is enabled to open up three connection paths 1425, 1426, and 1427 for any client that requests process number 1150. Connection path 1425 is for LAN communication, 1426 is for WI-FI, and connection path 1427 is for GPRS. The connection paths may be opened up only during the off-peak hours which according to the example would be between the hours of 6 pm and 5 am. In addition, the rule requires that the connection paths be used in decreasing priority based on the above defined preferences, so that the rule would require the use of the connection path using LAN as priority 1, the one using the Wi-Fi as priority 2 and the one using GPRS as priority 3. Finally, the rule allows the process number that is used by the mobile application to request and receive the large product catalog file from the plug-in to download that catalog by way of all three connection paths.

In the example, a mobile business application 1429 has requested the process number 1150 through client 1428. As previously discussed, this request was made by an API to client 1428 after first initiating a communication session with a gateway (not shown). The gateway has assigned the management of the plug-in with this process number 1450 to server 1424 in this example. If the request of the business application 1429 is made between the hours of 5 am and 6 pm, the communication would not be possible since no connection paths are permitted to be set up by the server during these hours according to the rule. Between the hours of 6 pm and 5 am when the rule permits the server to set up connection paths for process number 1450, the server is enabled to set up either of connection paths 1425, 1426, and 1427. The specific connection path that will be set depends on the availability of LAN, WiFi and GPRS functionality to the mobile device in which the mobile business application 1429 resides. If all three are available, then connection path 1 denoted by the element number 1425 will be used by the client for the download. In other words, the assignment of process number 1150 to connection paths 1 and 2 and 3 in the manager forces the client to first attempt to establish communications for this process using a LAN network and if this is unavailable to use Wi-Fi and if that too is unavailable then to use GPRS. If only Wi-Fi and GPRS is available, then the manager will force the client to establish connections for this process using Wi-Fi, that is by path 2 denoted by element number 1426. If GPRS is the only communication means available, then the manager will force the client to establish connections for this process using GPRS, that is by connection path 3 denoted by No. 1427 to enable mobile business application 1429 to receive process 1150.

In a similar way, the specific connection path that will be set by server 1434 which is managing the plug-in with process number 6920 designated by the element number 1420 depends on the availability of LAN, Wi-Fi and GPRS functionality to the mobile device in which the mobile business application 1439 resides. If all three are available, then connection path 1 denoted by the element number 1435 will be used. If only Wi-Fi and GPRS is available, then connection path 2 denoted by element number 1436 will be used. If GPRS is the only communication means available, then the server will set up connection path 3 to enable mobile business application 1439 to receive process 6920.

It is also illustrative that that the network connection path priorities are defined based on the administrator's preferences for having the data that will be exchanged as part of a requested plug-in process to be routed in some order of priority, through one of a plurality of supported network type connections (GPRS, WiFi, etc.) In addition, by excluding a supported network connection type from the list of defined connection paths, the administrator can restrict the data that is exchanged in a selected plug-in process from being transmitted through that type of network connection. For example: if the GPRS network connection type is removed from the software update plug-in process, then the client on the device will receive this information as part of the administrator defined communication rules and this restriction will not allow applications on the device to request software updates from this plug-in process, through a GPRS network connection.

Hence, from the foregoing description and description below, a connection path may be essentially a combination of a type of network connection, a plug-in process and a priority, which together with some additional properties including time, etc. can be used to control what plug-ins can be reached through what type of network connection. This information is used by the client to control what network connections it establishes and which plug-in processes can be requested through each connection.

As FIGS. 8 and 12 show, the foregoing rules configured the system to allow the large catalog file to be downloaded to a mobile device only during off-peak hours using all three available communication types, however forcing the client to automatically first attempt to download the file using a LAN connection, followed by a Wi-Fi connection and lastly if the prior two connection types are not available then to try to connect and download the file using GPRS. Hence, this disclosure provides a platform for enabling the manager assignment of process numbers based on time of day, manner of connection, and other events to control mobile communication costs.

Some other events may include but not be limited to the user of the device, the geographic location of the device—GPS, etc., as well as based on device events, such as a change in device health, reaching some threshold on battery power, signal strength, etc. For example, if battery power falls under 15% shut down the GPRS radio; or if the device happens to exit a defined GPS zone then the protocol could force communications to upload all business data from the device and wipe the device clean of any data.

FIGS. 8 and 12 also illustrates that a single, shared communication interface (for instance a data service 41) can be used to provide communication interfaces on one of its sides for the business applications 44. On the other side, the communication interface can communicate with network connections of a mobile device. Furthermore, the mobile computer may be configured so that the data service 41 of the client 43 handles all of the communication requests of the mobile applications 44 involving the network connections.

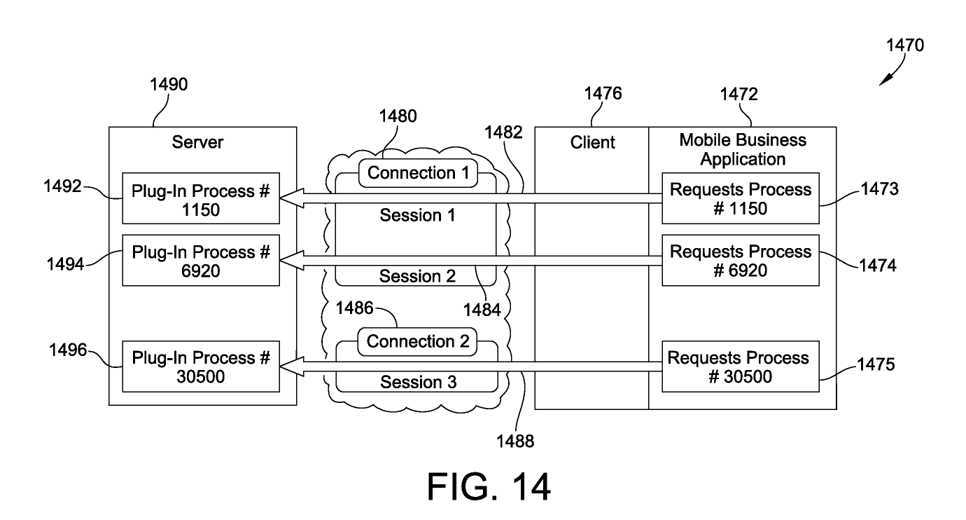

FIG. 14 further illustrates the abilities of the data service (41 in FIG. 8) of the disclosure to handle simultaneous processing using multiple connection paths allows the client (43 in FIG. 8) to handle several processes 1473, 1474, 1475 which are requested by the mobile applications 44 at the same time or in such rapid succession that the previously requested process 26 has not yet been completed before a new process 26 is generated by one or more of the mobile applications 44. In such case, the client may take advantage of an open connection for the new process depending on certain conditions. In such cases, the data service 41 on the mobile computer (20 in FIG. 8) first determines if a connection to a server 12 has already been established through any given connection path 1480, 1486 More specifically, if a connection has already been established, such as connection path 1480, then the client 43 will determine if the existing connection path may also be used for the subsequently requested process, such as process 1474, based on the rules for each process that has been set by the manager (e.g., type of communication, time of day, priority, etc.). If the newly requested process 1474 is set by the manager so as to be useable with the currently established connection (e.g. the newly requested process 26 may be used with the same type of communication as the currently established process, at the same time of day, and use of the currently established connection by the newly requested process otherwise satisfies all other rules that may be imposed by the manager), then the data service 41 will use the currently established for the connection. In this example, the currently established connection path 1480 was useable for the newly requested process 1474 and so FIG. 14 shows both process 1473 and 1474 using connection path 1480 for the communication.

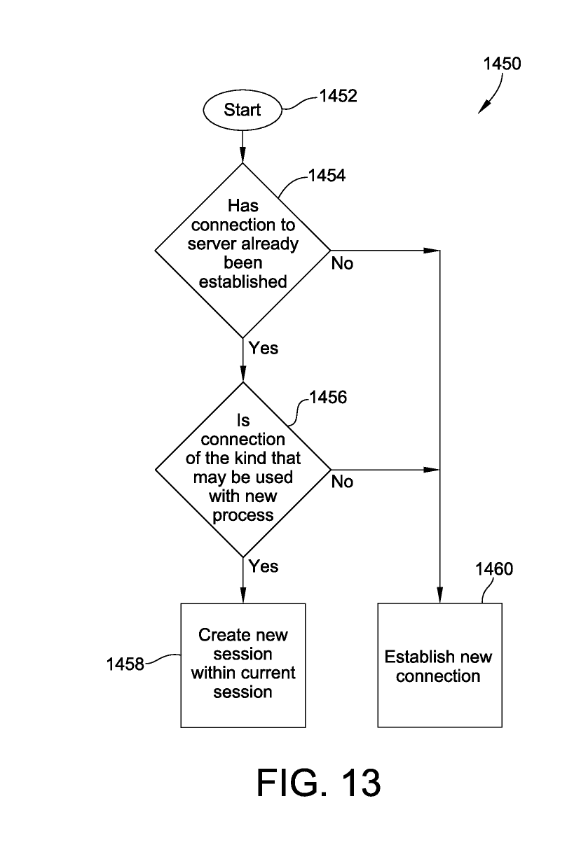

The specific process employed by the client to determine the usability of currently established connections by new process requests is shown in FIG. 13. This process 1450 employed by the client starts at step 1452. At step 1454, the client determines if a connection to a server has already been established through any given connection path. If a connection has already been established then at step 1454 the client will determine if that connection path may also be used for the new process being requested by the mobile application, based on the connection type of the connection path (ignoring the connection path priorities) defined in the manager (16 in FIG. 8). If the new process (50 in FIG. 8 being requested is also set to be able to use the currently established connection, then at step 1458, ignoring all priority settings, the client will create a new session within the current connection, to handle the data exchange for this new process. However, if at step 1454, the client determines that the new process being requested is defined in the manager as a connection that is the type of connection already established the client advances to step 1458 where the client will attempt to establish a new connection to handle this process, based on the defined connection path rules. The client automatically closes each connection after all sessions within a connection have terminated.

From the foregoing disclosure, each process that the mobile business application (44 in FIG. 8) requests via the client (43 in FIG. 8) must have a process number (50 in FIG. 8). This process number must correspond to a process number (70 in FIG. 8) that is associated with a plug-in process that is assigned to run on the server (12 in FIG. 8). Furthermore, the manager 16 can define various connection paths with different types of connectivity, even limiting the time of day when different types of connections can be established, and assign process numbers to each connection path to indicate when and through what type of connectivity each type of process may be requested by the client. For each process requested by the mobile business application the client will use the defined connection path information to automatically determine the type and priority of connections that may be established. The client knows what connection path rules have been defined in the manager because all the configuration settings, including connection path rules, defined in the manager that are to be used by the client on the mobile device, are automatically replicated to the mobile device and processed by the client each time the client attempts to connect to the system (1 in FIG. 8). The system may also use system plug-ins (not shown) that contain special processes which are used to exchange system data (not business data) between the servers (12 in FIG. 8) and the clients (43 in FIG. 8). These system plug-in processes may have process numbers in a range, such as starting with 32768 and higher, reserved for computing system 5 related operations. When such a process [2 in FIG. 8] is requested, the data service 41 can provide the connectivity for the client 43 as with the mobile applications 44.

As noted herein, each process 26 that a mobile application 44 can request via the data service 41 has a process number. This process number must correspond to a process number that is associated with a plug-in process 26 that is assigned to run on one of the server(s) 12. Various connection paths 64 (with different types of connectivity) can be defined using the system manager 16. These associations can limit the time of day when different types of connections can be established. These definitions can also (or in the alternative) assign process numbers to each connection path 64 to indicate when and through what type of connectivity each type of process 26 may be requested by particular mobile applications 44. For each process 26 requested by a mobile application 44 the data service 41 can use the defined connection path information (as discussed in FIGS. 12, 13, 14) to automatically determine the types and priorities of connections that may be established. To accomplish such functions (and/or others), all of the configuration settings, including connection path rules, (and which are to be used by the data service 41) in establishing connections, can be automatically replicated to the mobile computer 20 each time the client 43 attempts to connect to computing system 5.

Installation Support

Exemplary, but non-limiting operating systems which can be used on the mobile devices include the Windows Mobile 2003, Windows Mobile 5.0, Windows Mobile 6.1, Microsoft Windows XP (or later), Windows Embeded Handheld 6.5.3, etc. operating systems. It may also include the Android and iOS. Moreover, processors such as the (non-limiting) StrongARM, X-Scale, etc. processors can be used in the mobile computers 20 if desired. Other operating systems (and versions) and/or processors can be used on mobile computers 20 of embodiments though. In addition, memory provisions can also be made for the client 43, mobile applications 44, their data, etc. on the mobile devices 200.

Connection Paths

FIG. 14 illustrates network connections within a computing system. More specifically, FIG. 14 shows that a single, shared communication interface (for instance a data service 41) can be used to provide communication interfaces on one of its sides for the business applications 44. On the other side, the communication interface can communicate with network connections of a mobile device. Furthermore, the mobile computers [20 in FIG. 8] can be configured so that the data service 41 of the client 43 handles all of the communication requests of the mobile applications 44 involving the network connections.

FIG. 14 shows a client 1470 having a business application 1472 that makes three process requests—namely, a first request for process number 1150, a second request for process number 6920, and a third request for process number 30500. At the time that process request 6920 was made by the client, a connection 1480 was already in place for processing the process request 1150 that was earlier made by the client. In this example, the new process connection 6920 is the same kind of connection as is permitted for process 1150. Hence, the client has created a new session 1484, shown as session 2, to operate simultaneously with the original session 1482, shown as session 1, in connection with an earlier request by the business application of the client for process 1150. However, the third request 1475 for process number 30500 required the client to establish a new connection 1486 since the rules prohibited process 30500 to use connection 1480. A session 1488 named as “session 3” within connection 1486 is used for the communications requested by the mobile business application 1472 by the process number 30500 request.

From the foregoing disclosure, each process that the mobile business application (44 in FIG. 8) requests via the client (43 in FIG. 8) must have a process number (50 in FIG. 8). This process number must correspond to a process number (70 in FIG. 8) that is associated with a plug-in process that is assigned to run on the server (12 in FIG. 8). Furthermore, the manager 16 can define various connection paths with different types of connectivity, even limiting the time of day when different types of connections can be established, and assign process numbers to each connection path to indicate when and through what type of connectivity each type of process may be requested by the client. For each process requested by the mobile business application the client will use the defined connection path information to automatically determine the type and priority of connections that may be established. The client knows what connection path rules have been defined in the manager because all the configuration settings, including connection path rules, defined in the manager that are to be used by the client on the mobile device, are automatically replicated to the mobile device and processed by the client each time the client attempts to connect to the system (1 in FIG. 8). The abilities of the data service of this disclosure to handle simultaneous processing using multiple connection paths allows the client 43 to handle several processes 26 which are requested by the mobile applications 44 at the same time or in such rapid succession that the previously requested process 26 has not yet been completed before a new process 26 is generated by one or more of the mobile applications 44.

The system may also use system plug-ins (not shown) that contain special processes which are used to exchange system data (not business data) between the servers (12 in FIG. 8) and the clients (43 in FIG. 8). These system plug-in processes may have process numbers starting with 32768 and higher which illustratively may be range of process numbers reserved exclusively for use by system plug-in process).

### Multiple Connection Paths.

The ability of the client (43 in FIG. 8) to efficiently handle simultaneous processing using multiple connection paths is especially important in the event that several processes are requested by the mobile application (44) at the same time or in such rapid succession that the previously requested process has not yet been completed before a new process request is generated by the mobile application. In such case, the client may take advantage of an open connection for the new process depending on certain conditions.

Specifically, and as shown in FIG. 13, the process 1450 employed by the client starts at step 1452. At step 1454, the client determines if a connection to a server has already been established through any given connection path. If a connection has already been established then at step 1454 the client will determine if that connection path may also be used for the new process being requested by the mobile application, based on the connection type of the connection path (ignoring the connection path priorities) defined in the manager (16 in FIG. 8). If the new process (50 in FIG. 8) being requested is also set to be able to use the currently established connection, then at step 1458, ignoring all priority settings, the client will create a new session within the current connection, to handle the data exchange for this new process. However, if at step 1454, the client determines that the new process being requested is defined in the manager as a connection that is the type of connection already established the client advances to step 1458 where the client will attempt to establish a new connection to handle this process, based on the defined connection path rules. The client automatically closes each connection after all sessions within a connection have terminated.

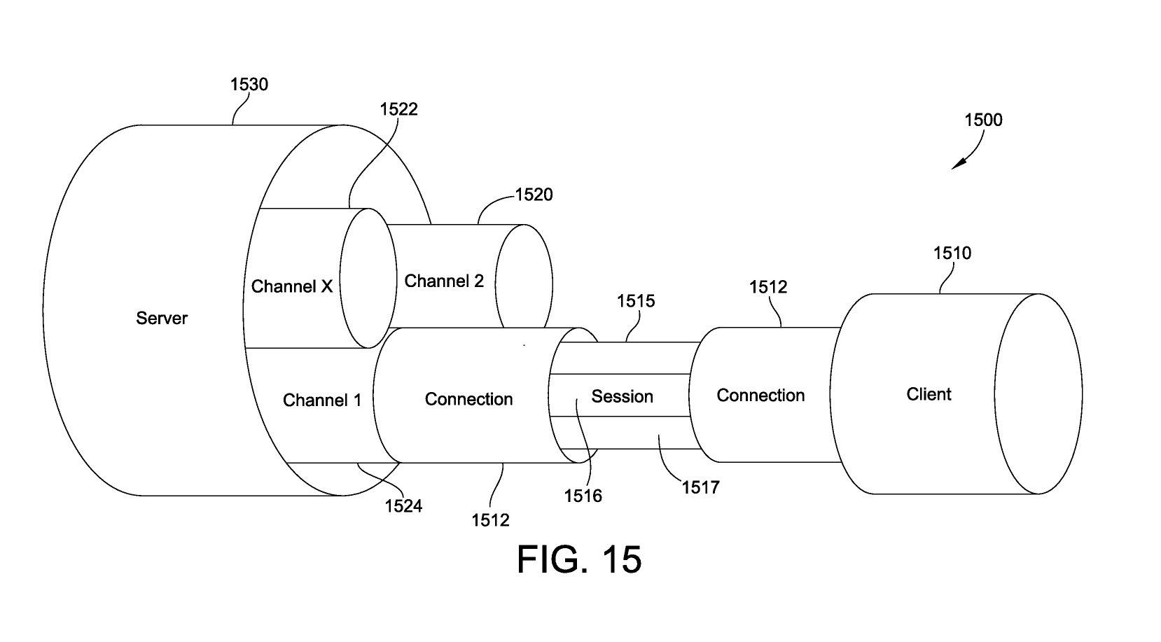

The structure of communication connections is illustrated in FIG. 15, each client 1510 is capable of initiating one connection 1512 with one server 1530 at a time. Each connection 1512 is established using one of the system supported connectivity options that the mobile device is capable of using, such as GPRS, Wi-Fi, LAN, etc. On the receiving side, each server 1530 is capable of handling many connections from many different clients at the same time. The maximum number of connections that can be handled by any given server is based primarily on the characteristics of the computer on which the server is installed and the number and complexity of plug-In processes assigned to that server. The server assigns each received connection a virtual identification number called a “Channel ID” which is used to identify that specific connection when providing information about it to a server console application (27 in FIG. 8). Therefore, a “channel” in the server console application is equivalent to a “connection” that is formed between a client and the monitored server.

Each connection is further divided into sessions 1515, 1516, 1517. Each connection may contain one or more sessions. A session is a virtual connection that is encapsulated within the physical network connection formed between a client and a server. Each connection in a system is independent from any other connection, and likewise each session is independent from any other session sharing the same connection. Sessions within a connection are created automatically by the client to handle the exchange of data between the client and the server for one specific process within a Plug-In (not shown but see 26 in FIG. 8). Each process number (50 in FIG. 8) requested by the mobile business application (44 in FIG. 1) via the client (43 in FIG. 1) will have its own dedicated session for the exchange of data. It may however share a single network connection with other sessions.

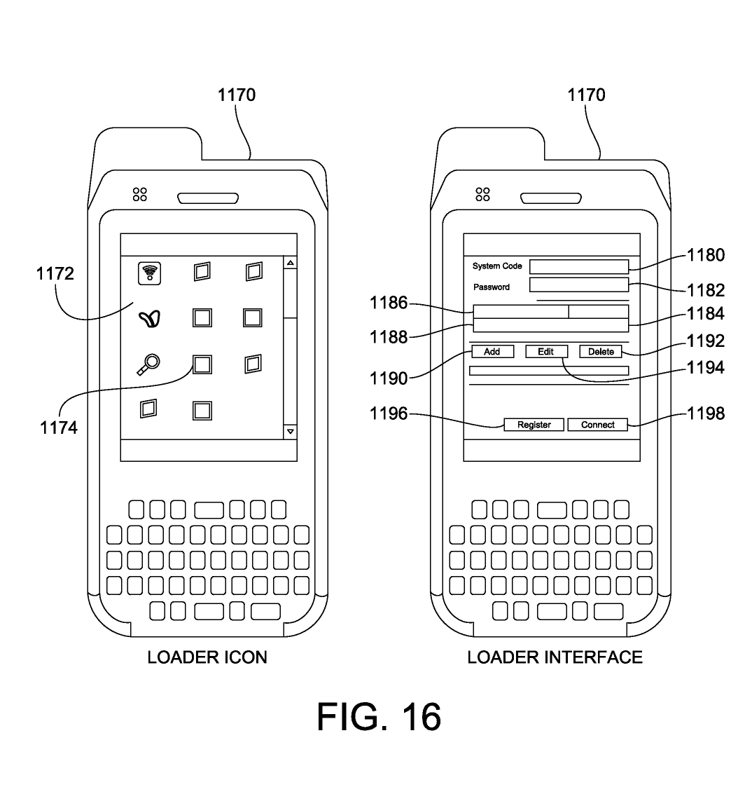

As shown in FIG. 16, a mobile computer 1170 wishing to download a process will call up an application program 1174 in the mobile computer that provides the graphical user interface that allows the user of the mobile computer to enter the process number and message information into the mobile computer in a manner in which the mobile computer will recognize the entered data. The user enters his system code 1180 and his password 1182 to open up the application program. A system code is a code used by the network for identifying a group of network users within the network. The group of network users within the network identified by the system code may be taken from the group consisting of deployment group, connection group, mandatory server group, and remote assist operator group. The group of network users identified by the system code may include an identification of individual users of the network. The individual user identification may be taken from the group consisting of employee. For details on the system code and how it may be used by the network to establish and manage network communications between a plurality of mobile applications on a mobile computing device and a server can be found in application entitled “System and Process for Managing Network Communications” filed contemporaneously herewith and is incorporated herein by reference.

Once the data has been entered through the graphical user interface and translated by the application program, the message is ready for transmission. Although in this illustrative example, data is entered through the graphical user interface, it should be noted that not all data that is to be transmitted has to originate from user input through a mobile business application GUI. For example, data transmission could be triggered based on temperature sensors in the cold storage of a truck's trailer, and the data to be transmitted could be the Device ID, GPS location and temperature data from the sensors. As another example, a trigger may be based on a device location. In this case, a device entering into or out of defined zones (e.g., based on GPS coordinates), could trigger an automatic upload of all data from the device followed by a device wipe. None of these inputs may be user inputs yet each of these inputs could trigger a communication with the network as previously described in connection with automated, self—triggered transmissions.

On depressing the send button on the mobile computer, the entered message is transmitted from mobile computer to the network of the mobile computer via LAN, Wi-Fi, GPRS, or other communication medium. At the network, the network will parse the fields that make up the message and look at the header field. From the data service field message, the network knows that this message is originating form a shared data service and so will route this message according to this disclosure to the gateway. At the gateway, the gateway will determine from the message architecture the client address (not shown) and the process being requested, as well as any message (not shown) that is provided by the client and the gateway will assign the management of the process to one of the servers in the network as discussed below. Particulars on these message architecture are disclosed in application Ser. No. ______ entitled application “Communication Protocol and System for Network Communications” filed contemporaneously herewith which is incorporated herein by reference.

Once the gateway has made the assignment to the server and the server has acknowledged and is ready to establish a connection with the client requesting the business process, the gateway will forward to the client the information required by the client to establish a communication session with the requested process on the assigned server. The client will establish the connection with the server using message protocol. The server will match the IP address provided by the client (not shown) with the client address that the gateway provided the server that the server received from the gateway that made the assignment to the server to manage the process. The server will also match the process requested by the client with the process number that the gateway provided to the server sent by the gateway to the server in making the assignment.

The client will then establish a communication session with the Plug-In Process on the target server which allows for data to be exchanged bi-directionally between the plug-in process and the mobile application that requested the process. Based on the bi-directional exchange of data between the plug-in process and the mobile application, the mobile computer is configured with the settings provided by the plug-in in order to enable the business application to seamlessly connect and communicate with the network.

Registering and Provisioning New Devices

As indicated in FIG. 8, before any mobile computer can connect to the system (core infrastructure 1) it must be registered for use in that system. To facilitate this process the mobile computer mus t have a live network connection through which the gateway and the server can be reached. As shown in FIG. 16 and previously discussed, a user may launch the Loader application 1174 on the mobile computer and click on the register button 1196 to make this registration. If a message indicating successful registration is received after registration of the message, the authentication credentials generated for the given computer's hardware was successfully received by the gateway. After an administrator accepts the remote device registration in the Manager (and assigns the newly registered device set to the appropriate device set template) the mobile computer will then be able to reconnect and have the mobile computer automatically provisioned with the correct device settings and software.

In the event that a registered mobile computer is cold booted (thereby resetting the computer to its default factory state) it is not necessary to re-register the computer to provision it since the registration credentials of the mobile computer resides on the network. A user may simply launch the Loader application on the computer and click the Connect button to initiate the provisioning process.

The Structure of Communications Connections

“Pull” and “Push” Data Communications

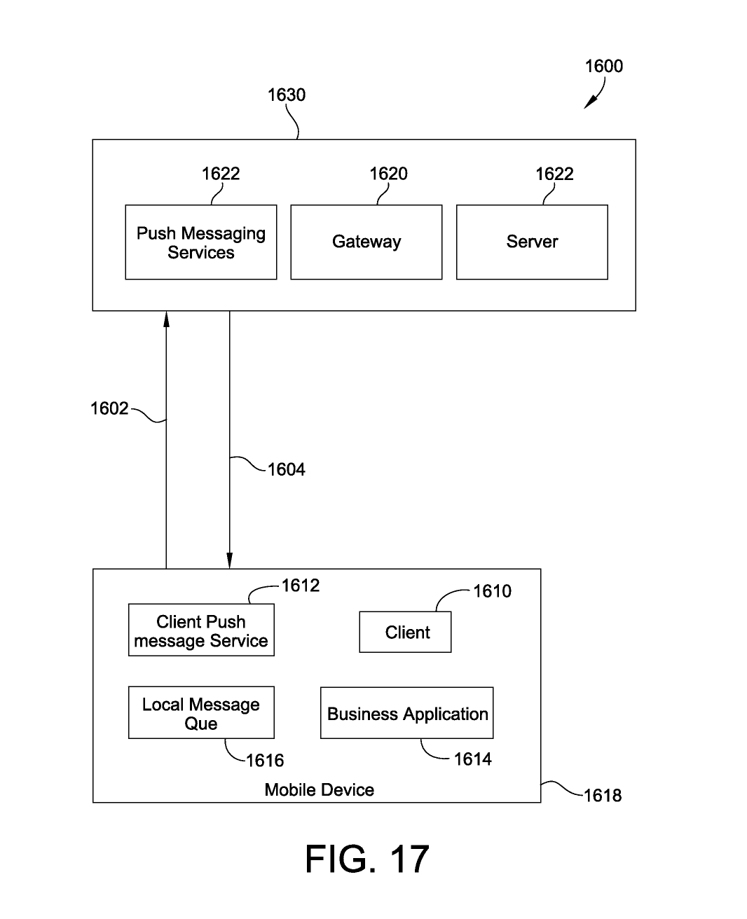

FIG. 17 shows a system 1600 for “pull” and “push” data communication. In a pull communication scenario, communication sessions are initiated by a client 1610 on a mobile device 1618. In a push communication scenario 1604, communication sessions are initiated by a gateway 1620 (typically on demand of a host system). Push communication scenarios 1604 are supported by the system 1600 through push messaging services 1622. These services allow host systems to initiate the exchange of business data by sending messages to a mobile business application 1614 on the mobile device 1618. These messages are intercepted by a client push message service 1612 on the mobile device, stored in a local message queue 1616, and the mobile business application 1614 obtains a system event letting it know that it can now fetch new messages from the queue. These messages can provide new business data to the mobile business application, they can encode instructions to the mobile business application (such as an instruction for it to request a specific process number which will provide it with new business data, etc.), and they can also be used to remotely launch applications on the mobile device.

Push Messaging provides the capability to send a small set of business data, on demand from a host system 1630 (for example, an ERP application, help desk and dispatch application, logistics management application) to the mobile business application 1614 running on the target mobile computing device 1618.

Push messages may contain business data that is being sent from the host system to the mobile business application running on the target mobile computing device. The system provides the software communications infrastructure to transmit and receive these push messages. The contents of each push message is determined by the needs of the host system from which the push message is originating. Host systems create push messages by inserting records into a special push message table within the Database (15 in FIG. 8. When the client push message service running on the target mobile decide receives a push message, this message is made available to the mobile business application which then interprets the message and determines what action to take. For example, depending on the contents of the data in the push message, the mobile business application may connect to the server 12 for a specific plug-in process 26; it may use the message contents to update data in its database; or it may simply display a pop-up window to the user with some instant message. In all cases however, the creation and interpretation of push message data is entirely controlled by the host system 1630 and the recipient mobile business application 1614 serves only as the secure platform through which system-wide push messages are transmitted.

Push messaging requires that the target mobile computing device is connected to the network 1630 and its IP Address is directly reachable from the gateway 1620. If the mobile computing device is connected to a network that is located behind a firewall or a network router that is using NAT (Network Address Translation) then the gateways may be unable to deliver push messages because they will be unable to locate the mobile computing device within the foreign network.

This same push messaging capability also provides the mechanism through which applications can be remotely launched on a mobile device and through which standard client communication sessions can be initiated, on demand, from the host system 1630.

Although push messaging provides a mechanism through which a standard client communication session can be initiated by the host system, this mechanism still relies on the mobile application to interpret the message contents when it is received and if appropriate, call the client to establish a connection to the server and request a specific plug-in process.

Check-Point Restart on Downloads

In the event that during the download of a file to the mobile computing device (20 in FIG. 8), the connection to the mobile computing device is dropped, for any reason, before the download can be completed, then when a connection is reestablished and the same file is requested again, the download will continue at the point of previous interruption. This is because throughout the download, the client is monitoring the progress of the file being downloaded.

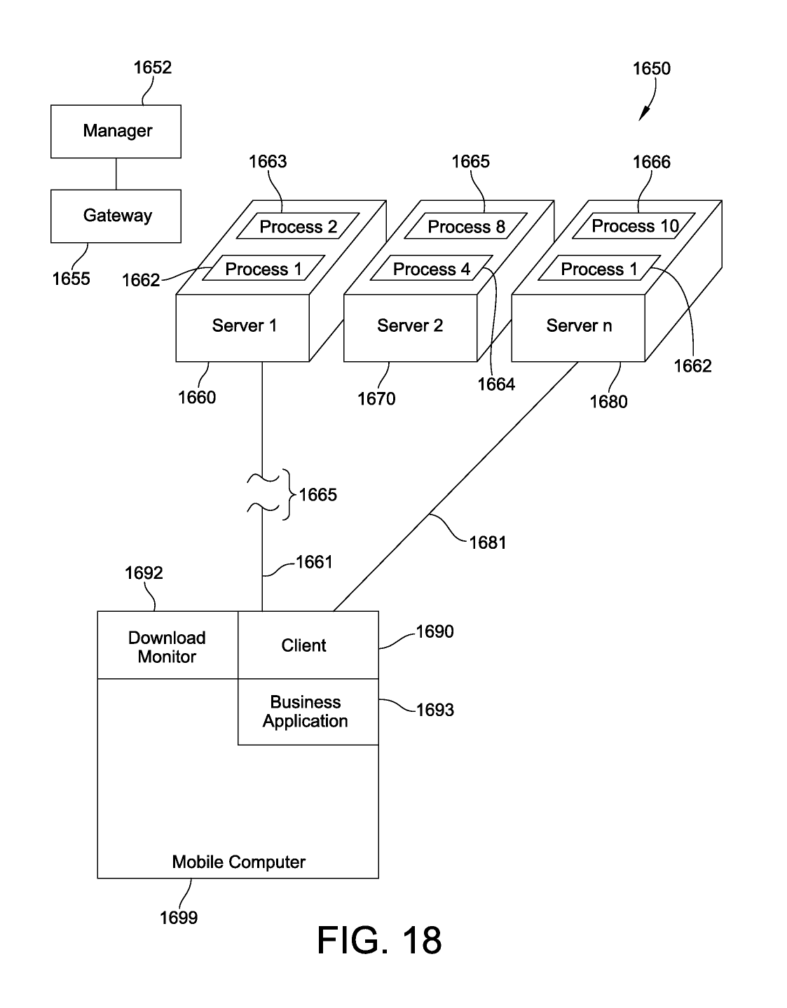

FIG. 18 shows a system with a check point restart on download feature 1650 comprising a manager 1652, a gateway 1655, servers 1660, 1670, and 1680 and client 1690. Server 1660 is enabled to manage processes 1662 and 1663. Server 1670 is enabled to manage process 1664 and 1665. Server 1680 is enabled to manage process 1662 and 1666. The system illustrates that process 1662 resides in both servers 1660 and 1680 and is manageable by both. The client has a download monitor 1692 for monitoring the download of a file to mobile computer 1699. A business application 1693 residing on mobile computer 1699 communicates with the client through a command file as previously discussed (not shown). Because process 1662 resides on both servers 1660 and 1670, the client may establish a first connection 1661 with server 1660 or a second connection 1681 with server 1680 as the channel to enable a request by the business application 1693 for the process 1650. In this illustration, the gateway has assigned the management of process 1662 to server 1660.

As previously discussed, the client will then establish a communication session with the plug-in process 1662 on the target server which allows for data to be exchanged bi-directionally between the plug-in process and the mobile application that requested the process. Based on the bi-directional exchange of data between the plug-in process and the mobile application, the mobile computer is configured with the settings provided by the plug-in in order to enable the business application to seamlessly connect and communicate with the network. In this example, the data requested by the mobile application is a source file.

When the check-point restart on downloads feature is working, system manager 1652 monitors the download of the requested source file from the process 1662 on server 1660 to the mobile computing device 1699 at the bit level. If the connection to the mobile computing device is dropped, before the download can be completed, for any reason, as shown by element 1665 in FIG. 18, the computing device may then attempt to make another request of the network for process 1662. As previously discussed, the request from the computing device will go to gateway 1655. In this example, the gateway assigns the new process request this time to server 1680 which, along with server 1660, also contains a copy of process 1662. The system manager 1652, which is notified of the assignment, will determine if the source file requested by the computing device is the same as the source file requested by the computing device before the interruption. If the source file is determined by the system manager to be the same at the bit level, the system manager 1652 will instruct process 1662 on server 1680 to start downloading the source file starting at the bit in the source file where the previous download of the source file was interrupted. In this way, the source file data downloaded by process 1662 on server 1680 will be a seamless continuation of the source file data downloaded by process 1662 on server 1660 before the interruption. The ability to quickily continue a large file download, at the point where communications were interrupted, without having to restart the file download from the beginning saves both time and money.

It is not necessary that the source file on the server-side be stored in the same location (such as a shared folder on a file server) to resume a file download but it is necessary that the file be identical at a binary level. The system automatically verifies that the source file, to be used to resume download, is identical to the one used during the previously attempted download. If the system determines that the file is not identical then the system will assume that the source file has changed (for example, the source file was overwritten by a new version of the file) and the file download will automatically restart at the beginning of the source file

Updating Mobile Business Applications

Mobile business applications are designed to receive, process and output business data in accordance with the data structures and data processing rules developed for the business application. As a consequence these business applications have built-in dependencies with respect to what data they need and how that data is expected to be provided. Due to these data dependencies the process of updating mobile business applications can be complex and typically requires the coordinated execution of mobile device software updates with updates of host systems and their data integration interfaces.

The system (5 in FIG. 8) is designed to help make the entire process of updating mobile business applications easier, faster, more flexible and with less risk. One of the fundamental features that make this possible is the use of version controlled plug-in processes that are requested as needed by the mobile business application. By specifying not only the process that is being requested but also its version, the mobile business application is able to connect to and exchange business data with those processes that are compatible with its data dependencies.

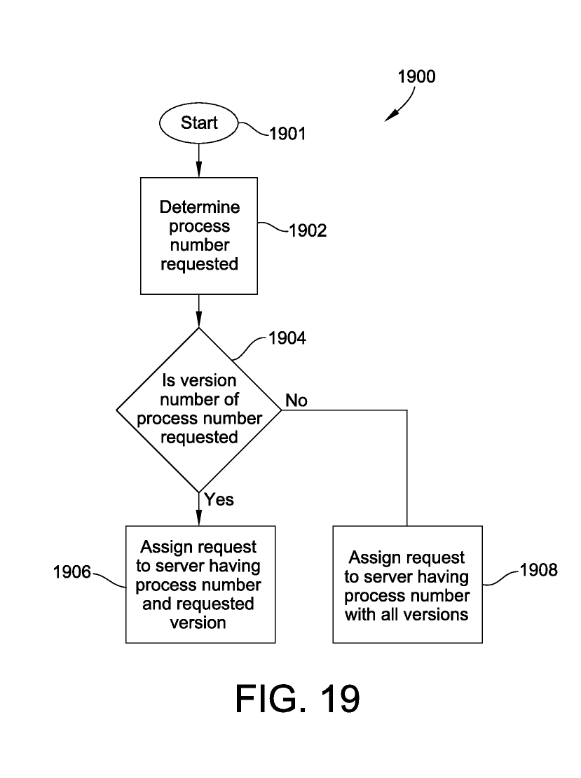

FIG. 19 shows a process 1900 for updating mobile applications. The process starts at step 1901. At step 1902, a gateway determines the process number requested by a business application through a client. At step 1904, the gateway determines whether the business application has also requested a specific version of the requested process. If YES, the gateway assigns the request to the server having the process number. and the requested version. If NO, the process assigns the request to a server having the process number with all versions. The manner in which the gateway makes these assignments to the server has been previously discussed.

When the mobile business application is updated in such a way that its data dependencies change, then the mobile business application may include in the updated application logic the new version number of the process with which it is now compatible. Because each mobile business application will request only those process versions with which it is compatible, it is possible to deploy and maintain within one mobile computing system, different versions of the same mobile business application without compromising the integrity of the host system data integration interfaces.

The ability to operate multiple versions of the same mobile business application at the same time allows a user to simplify new mobile business application deployment processes, avoid tedious and costly communication synchronization planning for the update process, and also offers unique advantages in software piloting and phased software rollouts.

To assure that updated mobile business applications will have access to their required process versions, the new plug-ins should first be installed and configured and then new business applications added to the business applications module in the manager.

Defining Communication Rules

The system allows the management of communications between mobile devices and host systems by grouping s ystem codes into c onnection groups. These groups are used to define the communication rules used by mobile devices to determine what type of network connection to open and which open network connection should be used to exchange different types of business data. Each system must have at least one connection group established before any mobile device communications can take place.

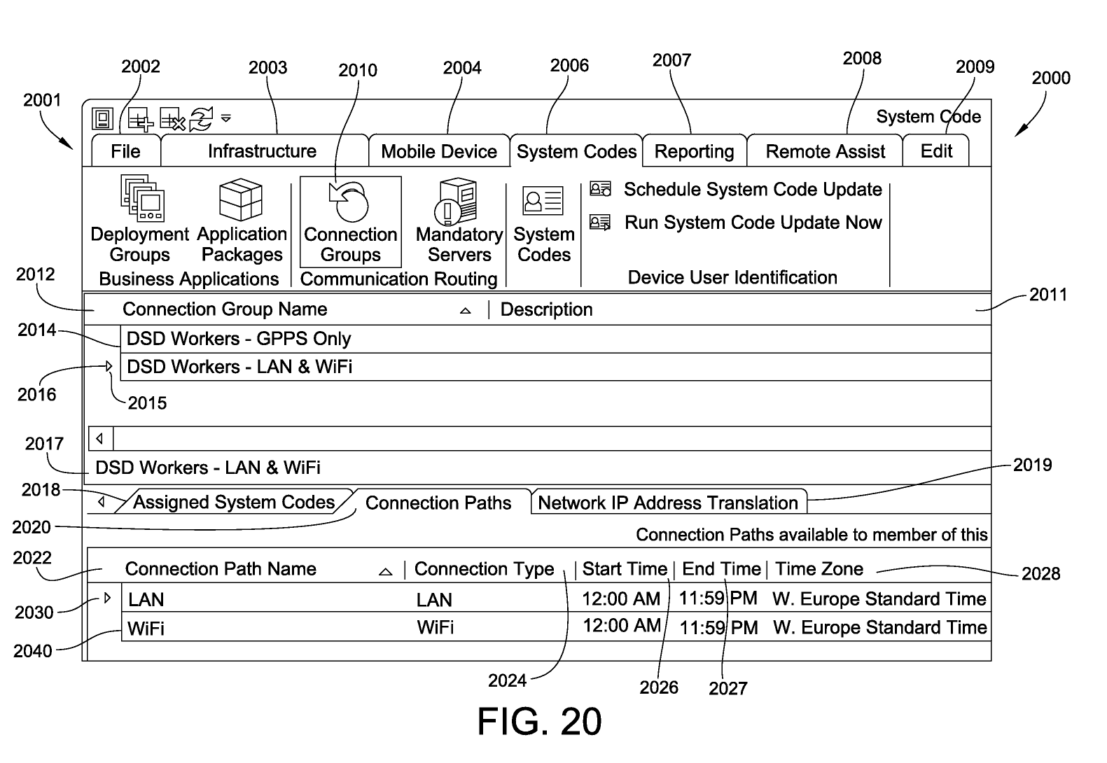

FIG. 20 shows a window 2000 that may appear on a display (not shown) of the system manager (16 in FIG. 8) illustrating the management of communications between mobile devices and host systems (1 in FIG. 8) by grouping system codes into connection groups. The window 2000 shown in FIG. 20 displays a toolbar 2001 that allows the user to display files by activating a file tab 2002, infrastructure by activating an infrastructure tab 2003, mobile devices by activating a mobile devices tab 2004, system codes by activating a system codes tab 2006, reporting by operating a reporting tab 2007, remote assist by activating a remote assist tab 2008, and edit by activation of an edit tab 2009 functions.

FIG. 20 illustratively shows the display appearing after the toolbar system codes tab 2006 has been activated followed by the activation of a connection groups tab 2010. The display shows a connection group listing 2012 including a first connection group 2014 DSD Workers—GPPS Only and a second connection group 2016 DSD Workers—LAN & WiFi. The arrow 2015 indicates that the second connection group 2016 DSD Workers—LAN & WiFi has been selected for display in a window 2017 appearing inside of the window 2000. Inside window 2017 is a tab 2018 which a user may use to navigate through the assigned system codes 2018, a tab 2020 which a user may use to navigate through connection paths, and a tab 2019 which a user may use to navigate through network IP address translation. In this FIG., the Connection Paths tab has been selected to display a tab 2022 for connection path names, a tab 2024 for connection types, a tab 2026 for start time, a tab 2027 for end time, and a tab 2028 for time zone.

As FIG. 20 shows, connection group listing 2012 includes one or more connection paths 2012 available to workers appearing on the listing. The arrow 2015 indicates that the second connection group 2016 DSD Workers—LAN & WiFi has been selected for display in the window 2017. In particular, from among different types of network connections (LAN, Wi-Fi, GPRS, CDMA, etc.) connection group 2014 which is DSD Workers are permitted to use GPRS only. These are the types of network connections that the client may open from the mobile device. On the other hand, connection group 2016 is DSD workers and they are permitted to use both LAN and WiFi.

As previously indicated, the arrow 2015 indicates that the second connection group 2016 DSD Workers—LAN & WiFi has been selected for display in the window 2017. Under the connection path name listing 2022 appears both LAN and WiFi connections that the connection group 2016 is permitted to use. As the window 2017 further shows each connection has been assigned its own set of privileges. In other words, a rule has been defined for each connection that defines when that connection may be used. To show this, the window 2017 has further listings for start time 2026, end time 2027, and time zone 2028. The LAN connection type 2030 is only permitted to be used between 12 am and 12 pm W Europe standard time. The Wi-Fi connection type 2040 is likewise limited to for use during these same times.

By creating various connection groups with different connection paths and assigned processes it is possible to establish different communication rules to meet the needs of different groups of device users. Each time a user modifies the parameters of a connection path or its assigned processes the user is modifying the rules that will be used by the client to manage mobile communications. Each device user will have his device provisioned with the communications rules specified by the connection group to which their submitted system code is assigned.

Automatic Selection of Connection Paths

By default, the client (43 in FIG. 8) will automatically select the connection path to use each time the mobile business application (44 in FIG.8) requests a specific process. This automated selection process is based on the connection path rules defined by the administrator in the manager (16 in FIG. 8) as described above. By configuring communication rules centrally and using the automatic selection of connection paths from each device (20 in FIG. 8) based on the requested process, the administrator is able to establish and enforce least-cost connection routing rules that are in-line with business process objectives.

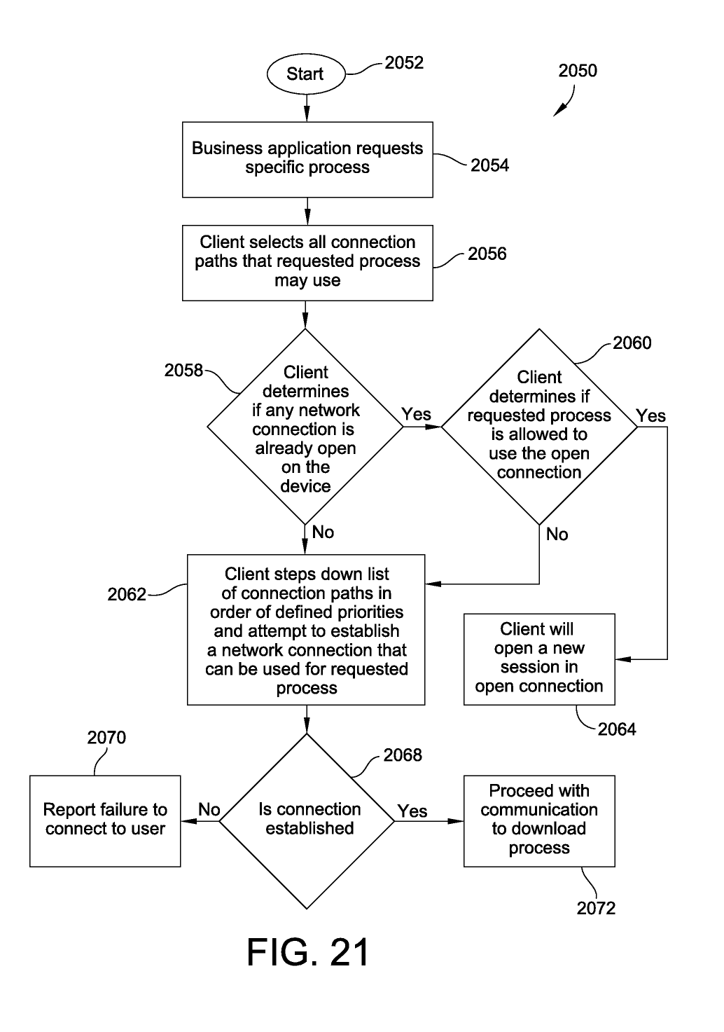

FIG. 21 shows a process 2050 for determining which connection path should be used. The process starts at step 2052. At step 2054, the business application requests a specific process. At step 2056, for each requested process, the client will select all connection paths that the requested process may use. At step 2058, the client will check to see if any network connection is already open on the device. If a connection is already open then the process advances to step 2060 where the client will check to see if the requested process is allowed to use the open network connection. If an open network connection is of the type that can be used for the requested process, at step 2064, the client will use it to open a new session in the open communication. If it is not one of the allowed types of network connections or no open network connection exists then at s t e p 2062, the client will step down the list of connection paths, in the order of their defined priorities, and at step 2068 attempt to establish a network connection that can be used for the requested process. If no network connection can be established (for example, if the device presently has no network connectivity options available to it) then at step 2070, the client will report this event to the mobile business application as failure to connect. If a network connection can be established, then at step 2072 the client proceeds with communication over the connection to download the process.

Manual Selection of Connection Paths

In some business scenarios it may be beneficial to allow the automatic connection path selection process on the device to be overridden by the device user. In these scenarios the client (43 in FIG. 8) can always provide the mobile business application (44 in FIG. 8) with a list of all the connection paths that may be used for its requested process. The mobile business application can display this list to the device user and use the user input to select the type of network connection to use, regardless of the administrator's predefined connection path priorities.

Allowing the manual selection of connection paths typically makes most sense in cases where there exists many network connection options for each device (20 in FIG. 8), yet at any given time and location the device user knows that only one of the lower priority connection paths is feasible. In these cases the ability to jump directly to the use of that type of network connection can be faster than the automated connection path selection process which must discover the feasible connection by stepping through its connection path rules.

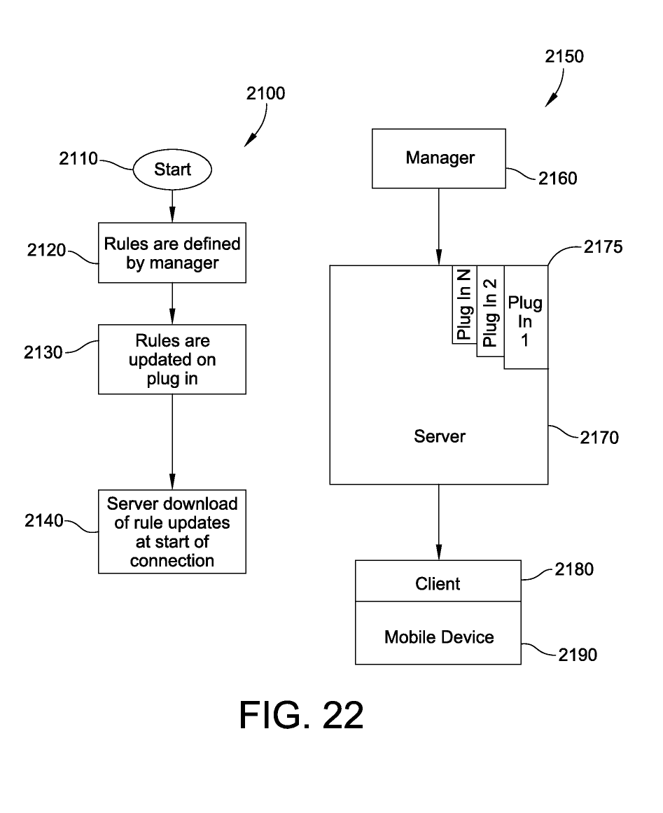

FIG. 22 shows a functional diagram 2150 and a process 2100 for updating connection rules on a client 2180. The communication rules are defined centrally in the manager 216 0 and must be updated on a mobile device 2180 before the client on that device can interpret these rules and modify its communication management behavior accordingly. The updates to the rules that are made by the manager appear in the plug ins 2175 residing on a server 2170. Communication rules are automatically updated on the device 2190 as needed, by a system plug-in, each time the client connects to a server 2170. According to the process 2100, at step 2120 the manager defines the rules. At step 2130, the rules are uploaded on the mobile device for use by the client In step 2140, the server downloads the updates at the start of a connection between a client and the servers. In this process, each device obtains those communication rules that relate to the connection group of which the submitted System Code is a member.

The communication protocol and system disclosed enables network communications between the data service (41 in FIG. 8) residing on the client (43 in FIG. 8) that provides network communications between a plurality of mobile applications (44 in FIG. 8) on the mobile computer (20 in FIG. 8) and the network (1 in FIG. 8) for the process number (50 in FIG. 8). The shared data service process takes care of details such as initiating network communications, opening a network connection to a gateway server, determining the server with which it will communicate, etc. The network takes care of managing each data service process in the network and the process numbers requested by the business applications through the shared data service. In one example, the protocol includes a data field in the message architecture that identifies the message as coming from the shared data service in network communications between the plurality of mobile applications on a source and the network for the process number. In another embodiment, the protocol

The shared data service disclosed enables improved mobile communication flexibility and reliability, enhanced data transmission security, better mobile device management and mobile application support, extensive control over mobile data exchange transactions, comprehensive monitoring of all communications and data processing. The data service provides for an open, flexible, secure and extensible platform to manage large numbers of mobile computing devices over a heterogeneous communications network.

The data service enables a reliable and highly scalable mobile communications system. This data service enables a system integrated with security, data management, device management, and extensible business application support features that organizations need to effectively deploy and manage mobile computing systems. The data service makes possible the use of a flexible, configurable, and scalable architecture that allows organizations to configure and operate the system according to the size and complexity of their information technology (IT) environment and business requirements.

The data service enables an open, flexible, secure and extensible platform to manage large numbers of mobile computing devices over a heterogeneous communications network. This is achieved by, among other things, allowing the specifics and peculiarities of various mobile devices, networks, and information technology infrastructures. The abstraction is used with respect to specific mobile business applications, and allows the system to achieve the goal of providing a standard software platform (non-customized but open to organizational specific extensions) which can be used in a variety of mobile computing system implementations.

It will be apparent to those skilled in the art that various modifications and variations can be made to the disclosed system and method. Other embodiments will be apparent to those skilled in the art from the consideration of the specification and practice of the disclosed system and method. It is intended that the specification and examples be considered as exemplary only, with a true scope being indicated by the following claims and their equivalents.

What is claimed is:

1. A mobile device comprising:
a memory;
a processor in communication with the memory; and
a plurality of connections in communication with the processor for communicating via a corresponding plurality of connection types with a network; the processor being configured to execute one or more mobile applications; and
the processor being further configured to execute an instance of a data service that provides network communications between the plurality of mobile applications and a server.

2. The mobile device of claim 1 wherein the data service is configured to accept commands from the plurality of mobile applications using a text-based mark-up language.

3. The mobile device of claim 2, wherein the text-based mark-up language is based on a standardized extensible markup language (XML).

4. The mobile device of claim 1, wherein the data service is configured according to contents of a configuration file, and wherein mobile applications register in the configuration file to use the data service.

5. The mobile device of claim 1, wherein the data service is configured to accept commands from each mobile application through a command file associated with the mobile application.

6. A method comprising:
providing a single instance of a data service executing on a mobile device, the data service providing network communications between a plurality of mobile applications on the mobile device an a server; and
accepting commands for the data service from the plurality of mobile applications, the commands instructing the data service to send data to or receive data from the server.

7. The method of claim 6 wherein the commands are provided using a text-based markup language.

8. The method of claim 6, further comprising configuring the data service according to the contents of a configuration file.

9. The method of claim 6, further comprising registering a mobile application with the data service by placing an entry for the mobile application in the configuration file.

10. The method of claim 6, wherein accepting commands for the data service comprises reading a command file in the data service, the command file associated with the mobile application that is sending the commands.

11. The method of claim 10, wherein reading a command file in the data services comprises reading the command file from an outbox directory associated with the mobile application that is sending the commands.

12. The method of claim 11, wherein reading the command file may be triggered based on an event.

13. The method of claim 12 wherein the event that may be triggered is based on a device status of the mobile device.

14. The method of claim 12 wherein the event that may be triggered is based on a device status of the mobile device.

15. The method of claim 7, wherein the text-based markup language comprises a standardized extensible markup language (XML).

16. A mobile device comprising:
a memory;
a processor in communication with the memory; and
a plurality of connections in communication with the processor for communicating via a corresponding plurality of connection types with a network;
the processor being configured to execute a plurality of mobile applications; and
the processor being further configured to execute a data service that provides network communications between the plurality of mobile applications and a server, the data service configured to accept data exchange requests from the mobile applications to establish communications between a requesting application and the network based on the data exchange request of the requesting application.

17. The mobile device of claim 16 wherein the data exchange request contains a configuration file for configuring the data service to establish a connection between the requesting application and the network in accordance with a process identified by the configuration file.

18. The mobile device of claim 17 wherein the data service initiates a connection with the network in response to the data exchange request for downloading a set of data associated with the requested process for configuring the data service in accordance with the process identified by the configuration file requested by the data exchange request from the requesting application.

19. The mobile device of claim 16 wherein the requested process configures the data service to establish a connection between the requesting business application and the network based on a priority rule.

20. The mobile device of claim 19 wherein the priority rule creates a priority between a plurality of communication protocols and wherein the data service is configured to use a one of the plurality of communication protocols available to the mobile device according to the priority for the connection to the network requested by the application.

21. The mobile device of claim 19 wherein the priority rule creates a priority between a plurality of periods of time and wherein the data service is configured to establish the connection of the requesting application to the network during one of the periods of time according to the priority.

22. The mobile device of claim 17 wherein the requested process configures the data service to establish a first connection between the requesting application and the network based on a first priority rule and a second requested process configures the data service to establish a second connection between a second requesting application and the network based on a second priority rule.

23. The mobile device of claim 17 wherein the requested process configures the data service to establish a first connection between the requesting application and the network based on a first priority rule and a second requested process configures the data service to establish a session within the first connection between a second requesting application and the network based on a second priority rule.

24. The mobile device of claim 16 wherein the mobile device is configured to route all communications of the business applications through the data service.

25. The mobile device of claim 16 further comprising an agent configured to be executed on the processor and being configured to monitor the mobile applications and to restart any mobile application which stops running

26. The mobile service of claim 16 further comprising a message service configured to be executed on the processor and to receive a push message from the network and to forward the push message to a mobile application associated with the push message.

27. A method comprising:
accepting data exchange requests from a plurality of business applications via a data service of a mobile device; and
for each data exchange request, establishing a communication between the requesting application and a network based on the data exchange request of the requesting application.

28. The method of claim 27 wherein the data exchange contains a configuration file for configuring the data service to establish a connection between the requesting application and the network in accordance with a process identified by the configuration file

29. The method of claim 27 further comprising the step of the requested process configuring the data service to establish a connection between the requesting business application and the network based on a priority rule.

30. The method of claim 27 further comprising the step of:
the requested process configuring the data service to establish a first connection between the requesting application and the network based on a first priority rule; and the step of
a second requested process configuring the data service to establish a session within the first connection between a second requesting application and the network based on a second priority rule.

31. The method of claim 27 further comprising the step of routing all communications of the business applications through the data service.

32. The method of claim 27 further comprising the step of receiving a push message from a network and forwarding the push message to an application associated with the push message via a message service of the mobile device.

33. A computer readable medium storing instructions which when executed by a processor cause the processor to perform a method comprising:
accepting data exchange requests from a plurality of business applications via a data service of a mobile device; and
for each data exchange request, establishing a communication between the requesting application and a network based on the data exchange request of the requesting application.

34. The computer readable medium of claim 33 wherein the data exchange contains a configuration file for configuring the data service to establish a connection between the requesting application and the network in accordance with a process identified by the configuration file

35. The computer readable medium of claim 33 further comprising the step of the requested process configuring the data service to establish a connection between the requesting business application and the network based on a priority rule.

36. The computer readable medium of claim 33 further comprising the step of: the requested process configuring the data service to establish a first connection between the requesting application and the network based on a first priority rule; and the step of a second requested process configuring the data service to establish a session with the first connection between a second requesting application and the network based on a second priority rule.

37. The computer readable medium of claim 33 further comprising the step of routing all communications of the business applications through the data service.

38. The computer readable medium of claim 33 further comprising the step of receiving a push message from a network and forwarding the push message to an application associated with the push message via a message service of the mobile device.
